(19) United States
(12) Patent Application Publication
(10) Pub. No.: US 2025/0065281 A1
(43) Pub. Date: Feb. 27, 2025

(54) Method for forming a dispersion comprising drops, and associated apparatus

(71) Applicant: CAPSUM, Marseille (FR)

(72) Inventors: Mathieu GOUTAYER, Saint-Malo (FR); Amélie PUJOL, Marseille (FR); Ophélie SAMMASSIMO, Villargondran (FR); Morgane FOREST, Marseille (FR); Séverine COURTADE, Ousse (FR)

(21) Appl. No.: 18/713,093

(22) PCT Filed: Nov. 25, 2022
(86) PCT No.: PCT/EP2022/083317

§ 371 Date: May 23, 2024

(30) Foreign Application Priority Data
Nov. 26, 2021 (FR) FR2112591

(51) Int. Cl. B01F 23/41; B01F 33/3011

(52) U.S. Cl. CPC B01F 23/4105; B01F 23/4144; B01F 33/3011; B01F 23/4145

(57) ABSTRACT

This method comprises the following steps: (i) formation of drops of a first phase in a second phase substantially immiscible with the first phase; (ii) flow, in a flow line, of the drops; (iii) recovery of a dispersion comprising drops and second phase in a container; and (iv) injection of a solution into the flow line or at the outlet of the flow line, upstream of the container, the solution comprising at least one raw material which is not or is not very compatible with step (i) and/or step (ii).

The present invention relates to a method for formatting a dispersion containing macroscopic drops, comprising the following steps:
(i) formation of drops of a first phase in a second phase substantially immiscible with the first phase;
(ii) flow of the drops, in a flow line;
(iii) recovery of a dispersion comprising drops and of the second phase in a container.

The “microfluidic” method is intended e.g. to form a single dispersion, of the oil-in-water or water-in-oil type, or a multiple dispersion, e.g. of the water-in-oil-in-water, oil-in-water-in-oil or oil-in-oil-in-water type, comprising stable drops of dispersed phase of a size greater than or equal to 100 microns.

Application WO 2012/120043 describes a “microfluidic” manufacturing method of the aforementioned type. The method serves to produce a single stable dispersion of drops of a first phase in a second phase substantially immiscible with the first phase. Each drop has a core formed of the first phase and a very fine shell. The shell is formed by a very thin layer of coacervat, interposed between the first phase and the second phase to provide the stability of the drops.

Application WO 2017/046305 also describes “microfluidic” method of manufacturing a single dispersion of the aforementioned type where the first phase comprises at least one gelling agent, in particular a thermosensitive gelling agent, which serves to obtain dispersions with a further improved kinetic stability.

Variants of the aforementioned “microfluidic” methods for forming multiple dispersions such as described in WO2018077977 or FR3063893 should also be noted.

Finally, applications PCT/EP2021/063596 and PCT/EP2021/063598 describe a “microfluidic” manufacturing method for dispersion of the aforementioned types but devoid of shell while remaining satisfactory in terms of kinetic stability.

Such “microfluidic” methods are particularly sensitive and many parameters can alter the robustness thereof and/or the kinetic stability of the dispersions obtained. More particularly, the second phase should be sufficiently fluid and homogeneous to lead to a good emulsification at the injection line of the first phase into the second phase.

Thereby, in the “microfluidic” methods, the suspension of the drops is generally ensured by the use in the second phase of at least one pH-dependent gelling agent, generally of the carbomer type, e.g. the gelling agents marketed by Lubrizol under the name Carbopol. The gelling/suspending effect of the carbomers is activated by the “neutralization” of the second phase by the addition of a viscosity-increasing solution increasing the pH. Thereby, before formation of the dispersion, the second phase is provided with an acidic pH, namely comprised between 3.5 and 5.5, preferably between 4 and 5, in order to guarantee a fluidity compatible with the microfluidic method; in a second step, the gelling of the second phase is carried out by means of a step of injecting the solution for increasing the viscosity of the second phase into the flow line or at the outlet of the flow line, upstream of the container, as described in Application WO2015055748. In other words, the viscosity-increasing solution of the second phase is injected after formation of the drops of the first phase, into the second phase.

Such “microfluidic” methods are particularly effective for forming stable drops of perfectly controlled size and exhibiting very satisfactory optical properties.

Nevertheless, the inventors observed that the presence of certain raw materials in the second phase may prove to be detrimental to the proper performance of the aforementioned microfluidic emulsification step (i) and/or flow step (ii).

As an illustration, the inventors observed the following constraints:
phenomena of blockage of the constituent channels of the microfluidic device linked to the presence in the second phase of (i) reflective particles, in particular pearlizers, or (ii) raw materials which form precipitates, in particular by interaction with certain constituent elements of the microfluidic device.
certain raw materials induce an increase in the pH of the second phase, and hence an “activation” of the gelling/suspending effect of the carbomer, to the point that the flow of the second phase in the line(s) of the microfluidic device becomes impossible.
certain raw materials deteriorate in contact with the second phase at acidic pH, and/or
certain raw materials, at acidic pH, modify the surface tension of the second phase which can hinder, or even make the formation of drops impossible.

A first option aimed at overcoming such drawbacks would consist in feeding the raw materials into the solution for increasing the viscosity of the second phase described in WO2015055748. However, said raw materials are generally not compatible with satisfactory solubilization/dispersion in the viscosity-increasing solution, in particular due to suspension and/or pH issues.

A second option aimed at overcoming such drawbacks would consist, after recovery of the dispersion, in considering a step of adding an additional phase comprising the raw materials which are not or are only slightly compatible with the microfluidic emulsification step. However, such an option is not desirable because:
(1) same would be based on an independent and discontinuous step complicating the manufacturing method,
(2) the shear generated by mixing the additional phase with the continuous phase of the dispersion is likely to result in drop deformation and/or breakage, and
(3) a satisfactory homogenization of the additional phase with the continuous phase of the dispersion is not guaranteed.

In the field of cosmetics, such constraints lead to limitations in terms of dosage, aesthetics, cosmetic effectiveness, sensorial experience and/or coverage which, for obvious reasons, is not desirable.

A goal of the invention is thereby to provide a single “microfluidic” manufacturing method for a dispersion containing macroscopic drops in stable suspension in a continuous phase comprising raw materials which are not compatible or not very compatible with the microfluidic emulsification step (abovementioned step (i)) and/or the step of flowing the dispersion into the line of the microfluidic device (i.e. abovementioned step (ii)), while minimizing the handling to be performed on the product.

To this end, the subject matter of the invention is a method of the aforementioned type, characterized in that the method includes at least the following step (iv):
injection of a solution into the flow line or at the outlet of the flow line, upstream of the container, said solution comprising at least one raw material which is not compatible or not very compatible with the abovementioned microfluidic emulsification step (i) and/or the flow step (ii).

Hereinafter in the description, the solution comprising at least one raw material which is not compatible or not very compatible with the abovementioned step (i) and/or step (ii) may be referred to interchangeably by the expression “solution 62” or “additional solution” or “AF”.

As illustrated by the examples, a “microfluidic” method according to the invention is advantageous in that same serves to manufacture dispersions, single or multiple, comprising stable macroscopic drops, of controlled size and with satisfactory optical properties while being compatible with a use, in the second-phase, of raw materials which are not compatible or not very compatible with the abovementioned step (i) and/or step (ii) in a continuous, simple and robust way.

The method according to the invention can comprise one or a plurality of the following features, taken individually or according to any technically possible combination:
the drops and the second phase flow along a local axis in the flow line, the injection of the additional solution taking place substantially parallel, or even coaxially, with the local axis;
the injection of the additional solution includes bringing at least part of the solution to the center of the flow of the drops and of the second phase;
injection of the additional solution includes bringing at least part of the solution to the periphery of the flow of the drops and of the second phase;
the method includes a reduction in the cross-section of the flow of the drops and of the second phase, downstream of the injection of the additional solution;
the injection of the additional solution is carried out at the outlet of the flow line;
the method includes, upstream of step (ii) of flow (or of circulation), a step of formation of drops in the flow line;
the driving step comprises the following sub-steps:
   supply of a first fluid comprising the first phase and optionally at least one first precursor polymer of the coacervate and/or at least one gelling agent, in particular a thermosensitive gelling agent, contained in the first phase;
   formation of drops of first fluid in a second fluid intended to form the second phase, the second fluid advantageously circulating in the flow line upstream of the injection of the additional solution;
   optionally, supply of at least one second coacervate precursor polymer and/or at least one gelling agent, in particular a thermosensitive gelling agent, into the second fluid;
the injection of the solution (62) includes bringing at least part of the solution (62) into a solution distribution ring (210) located in the center of the flow line (38), the drops (12) flowing through a central passage (212) delimited by the ring (210) and through a peripheral passage (214) delimited between the ring and the flow line (38).
the method includes, at least one injection step (v) of injecting a solution for increasing the viscosity of the second phase such that the solution is injected into the flow line or at the outlet of the flow line, upstream of the container, before, simultaneously with or after the injection step (iv) of injecting the additional solution.
the injection of a first viscosity-increasing solution, suitable for increasing the viscosity of the second phase,
the method comprising after the recovery step, the following steps:
   recirculation of the intermediate dispersion comprising a second phase of partially increased viscosity;
   injection of a second viscosity-increasing solution into the intermediate dispersion;
the recirculation step includes the circulation the dispersion in an additional line, then recovering the dispersion in a container at the outlet of the additional line, the injection of the second viscosity-increasing solution being carried out in the additional line, or at the outlet of the additional line, upstream of the container;
the viscosity-increasing solution (63) contains a base;
the injection of the solution (63) includes bringing at least part of the solution (63) into a solution dispensing ring (210) located in the center of the flow line (38), the drops (12) flowing through a central passage (212) delimited by the ring (210) and through a peripheral passage (214) delimited between the ring and the flow line (38).

A further subject matter of the invention is an apparatus for forming a dispersion comprising droplets, comprising:
a flow line containing drops of the first phase in a second phase substantially immiscible with the first phase, optionally each drop (12) comprising a core (17) formed of the first phase (14) and a shell (18), preferably formed of a coacervate layer interposed between the first phase (14) and the second phase;
a container for collecting a dispersion comprising drops and the second phase; characterized in that the apparatus includes:
a tank containing a solution comprising at least one raw material which is not compatible or not very compatible with step (i) of microfluidic emulsification and/or step (ii) of flow of the dispersion into the line (38);
at least one injection line for the additional solution, coupled to the tank, coming out into the flow line or at the outlet of the flow line, upstream of the container.

The apparatus according to the invention can comprise one or a plurality of the following features, taken individually or according to any technically possible combination:
the flow line extends along a local axis of circulation of the drops and of the second phase, the injection line coming out coaxially with the local axis;
the apparatus includes a peripheral injection line for injecting at least part of the additional solution, coming out at the periphery of the flow line and/or a central injection line for injecting at least part of the additional solution, coming out at the center of the flow line;
the apparatus includes unit for forming drops in the flow line, the unit for forming drops advantageously including:
a line for supplying a first fluid comprising the first phase and optionally at least one first precursor polymer of the coacervate and/or at least one gelling agent, preferably a thermosensitive gelling agent, contained in the first phase (14);
a line for forming drops of first fluid in a second fluid intended to form the second phase, optionally the second fluid (40) containing or receiving at least one second precursor polymer of the coacervate and/or at least one gelling agent, preferably a thermosensitive gelling agent.

A dispersion according to the invention has the advantage of being stable (or “kinetically stable”), in particular over time and during transport.

“Stable”, as defined by the present invention, refers in particular, to the absence of creaming or sedimentation of the drops of phase dispersed in the continuous phase, the absence of opacification of the continuous phase, the absence of aggregation of the drops with one another, and in particular the absence of coalescence or of Ostwald ripening of the drops between each other, and the absence of leakage of materials from the dispersed phase toward the continuous phase, or vice versa.

Within the context of the present invention, the aforementioned dispersions can be designated indifferently by the term “dispersions”.

According to another embodiment, the dispersions according to the invention do not comprise any surfactant.

The invention will be better understood upon reading the following description, given only as an example and making reference to the enclosed drawings, wherein:

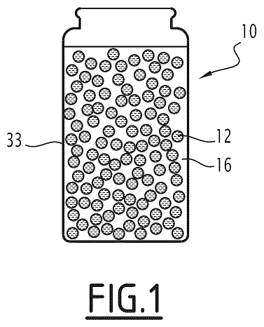

FIG. 1 is a side view of a container containing a single dispersion obtained by a first method according to the invention;

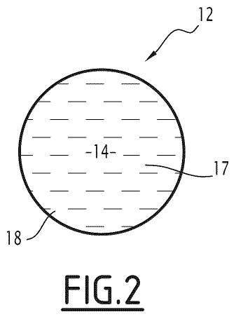

FIG. 2 is a sectional view of a drop of a single dispersion according to the invention;

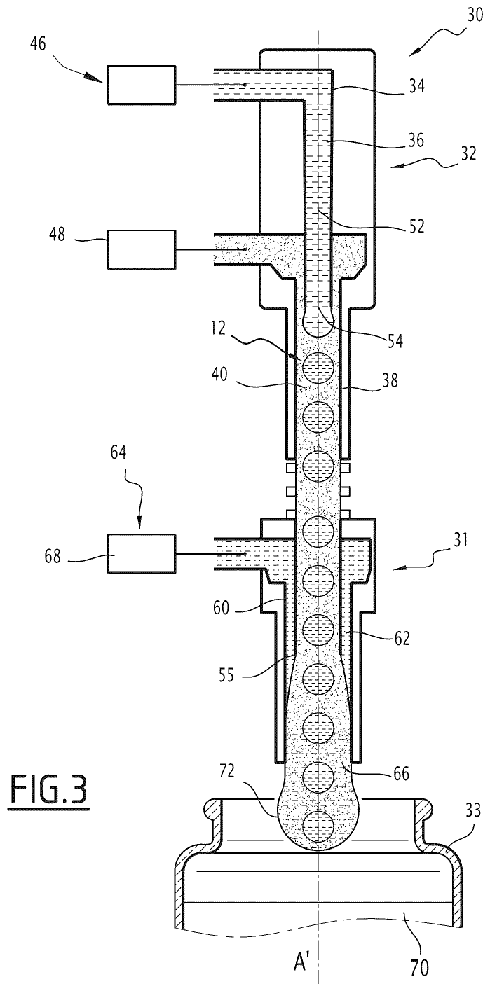

FIG. 3 is a schematic partial sectional view of a first apparatus for the manufacturing of a single dispersion, for the implementation of the first method;

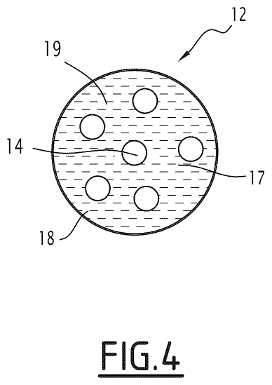

FIG. 4 is a sectional view of a drop of a multiple dispersion according to the invention;

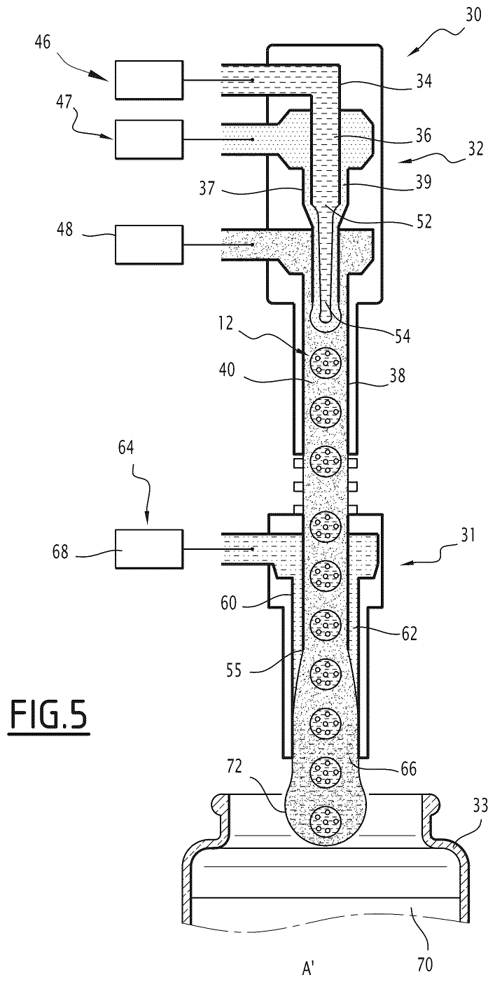

FIG. 5 is a schematic partial sectional view of a first apparatus for manufacturing a multiple dispersion, for the implementation of the first method;

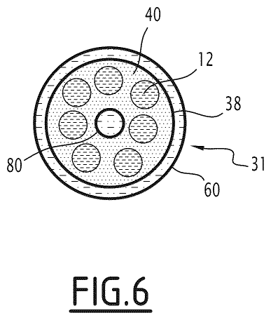

FIG. 6 is a view of a detail of the end of a flow line of a variant of the apparatus according to the invention, where the injection of an additional solution takes place at the end of the flow line;

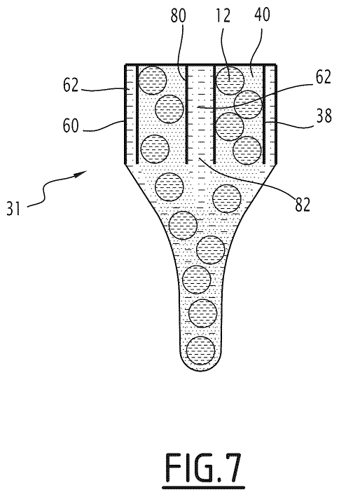

FIG. 7 is a top view of the end represented in FIG. 6;

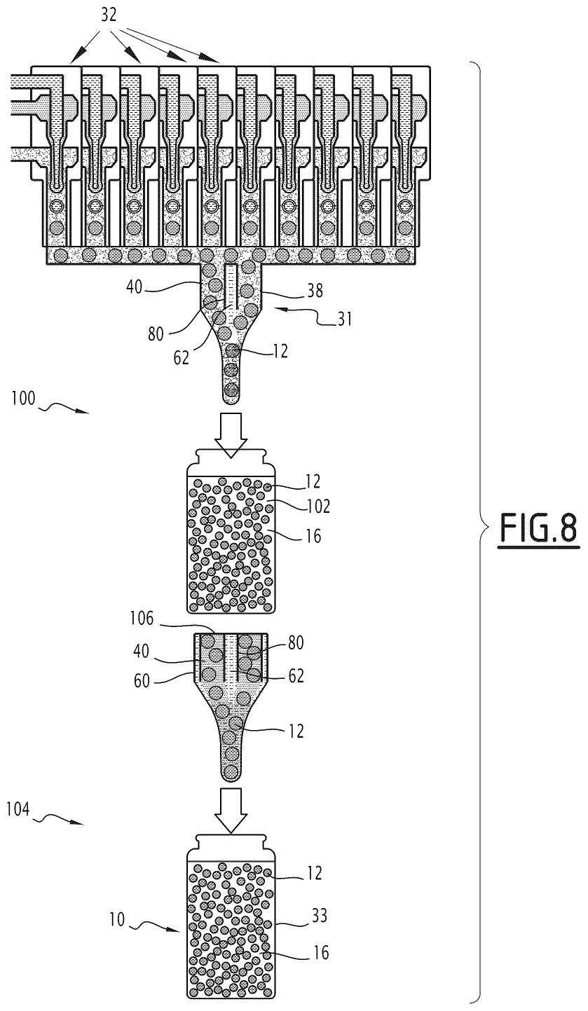

FIG. 8 is a view similar to FIG. 5 of a variant of an apparatus for manufacturing a multiple dispersion, for the implementation of a second method according to the invention;

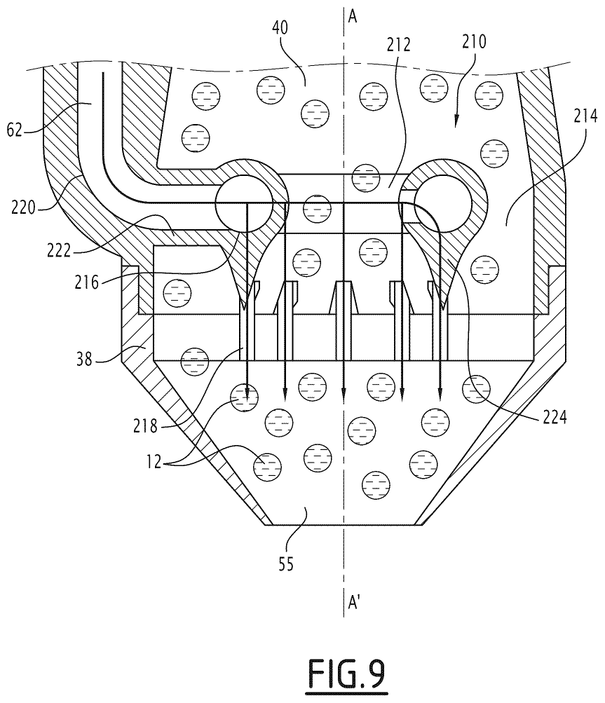

FIG. 9 is a sectional view similar to FIG. 6, of another apparatus according to the invention.

FIGS. 1 to 3 illustrate the implementation of a first method for forming single dispersions according to the invention.

FIGS. 4 and 5 illustrate the implementation of a first method for forming multiple dispersions according to the invention.

### Temperature and Pressure

Unless otherwise indicated, hereinafter, the temperature is considered to be the ambient temperature (e.g. T=25° C.±2° C.) and the pressure is considered to be atmospheric pressure (760 mm Hg, or 1,013.10⁵ Pa or 10¹³ mbar).

### Immiscibility

The first phase 14 (or dispersed phase) and the second phase 16 (or continuous phase) are substantially immiscible. According to a particular embodiment, a dispersion according to the invention can be a multiple emulsion and therefore resort to the use of a third phase 19 (intermediate phase) located between the first phase 14 and the second phase 16 as illustrated in FIG. 4. Thereby, the first phase 14 and the third phase 19 are substantially immiscible and the third phase 19 and the second phase 16 are substantially immiscible. More particularly, in a multiple dispersion according to the invention:
the first phase 14 is aqueous, the third phase 19 is oily and the second phase 16 is aqueous (i.e. water-in-oil-in-water dispersion),
the first phase 14 is oily, the third phase 19 is aqueous and the second phase 16 is oily (oil-in-water-in-oil dispersion), or
the first phase 14 is oily, the third phase 19 is oily and the second phase 16 is aqueous.

“Substantially immiscible”, as defined by the present invention, means that the solubility of a first phase in a second phase is advantageously less than 5% by weight.

### Aqueous Phase

The aqueous phase according to the invention comprises water. In addition to distilled or deionized water, a water suitable for the invention can also be a natural spring water or a floral water.

According to one embodiment, the mass percentage of water of the aqueous phase is at least 30%, preferably at least 40%, more particularly at least 50%, and better at least 60%, in particular comprised between 70% and 98%, and preferentially comprised between 75% and 95%, relative to the total weight of said continuous phase.

According to a particular embodiment, in particular when the aqueous phase of the dispersion according to the invention is the continuous phase and the latter comprises at least one carbomer, same may also comprise at least one base. Same may comprise a single base or a mixture of a plurality of different bases. According to a particular embodiment, the presence of at least one base in said aqueous continuous phase contributes in particular to increasing the viscosity of the latter.

According to one embodiment, the base present in the aqueous phase is an inorganic base. According to one embodiment, the inorganic base is chosen from the group consisting of alkali metal hydroxides and alkaline earth metal hydroxides. Preferably, the inorganic base is an alkali metal hydroxide, and in particular NaOH. According to one embodiment, the base present in the aqueous phase is an organic base. Organic bases include e.g. ammonia, pyridine, triethanolamine, aminomethylpropanol or else triethylamine.

A dispersion according to the invention can comprise from 0.01% to 10% by weight, preferably from 0.01% to 5% by weight, and preferentially from 0.02% to 1% by weight of base, preferably an inorganic base, and in particular NaOH with respect to the total weight of the aqueous phase comprising same, or even of the dispersion.

### Oily Phase

An oily phase (or fatty phase) according to the invention comprises at least one oil, at least one lipophilic gelling agent, and a mixture thereof, preferably at least one oil.

### Oils

The oily phase may comprise at least one oil, preferably wherein the cationic polymer as described hereinafter (when present) is soluble.

“Oil” refers to a fat that is liquid at ambient temperature.

As oils which can be used in a dispersion according to the invention, mention may be made e.g. of:
hydrocarbon oils of vegetable origin, such as hydrogenated jojoba oil, hydrogenated sunflower oil, hydrogenated castor oil, hydrogenated coconut oil;
hydrocarbon oils of animal origin, such as perhydrosqualene and squalane;
synthetic esters and ethers, in particular of fatty acids, such as oils with the formulae R1COOR2 and R1OR2 wherein R1 represents the residue of a C₈ to C₂₉ fatty acid and R2 represents a C₃ to C₃₀ hydrocarbon chain, branched or unbranched, such as Purcellin oil, isononyl isononanoate, isodecyl neopentanoate, isostearyl neopentanoate, isopropyl myristate, ethyl-2-hexyl palmitate, octyl-2-dodecyl stearate, octyl-2-dodecyl erucate, isostearyl isostearate; hydroxy esters such as isostearyl lactate, octylhydroxystearate, octyldodecyl hydroxystearate, diisostearyl malate, triisocetyl citrate, heptanoates, octanoates, decanoates of fattu alcohols; polyol esters such as propylene glycol dioctanoate, neopentyl glycol diheptanoate and diethylene glycol diisonanoate; and pentaerythritol esters such as pentaerythrityl tetrabehenate (DUB PTB) or pentaerythrityl tetraisostearate (Prisorine 3631);
linear or branched hydrocarbons of mineral or synthetic origin, such as paraffin oils, either volatile or not volatile, and the derivatives thereof, petroleum jelly, polydecenes, hydrogenated polyisobutene such as Parleam oil;
silicone oils, such as volatile or non-volatile polymethylsiloxanes (PDMS) with a linear or cyclic silicone chain, liquid or pasty at room temperature, in particular cyclopolydimethylsiloxanes (cyclomethicones) such as cyclohexasiloxane and cyclopentasiloxane; polydimethylsiloxanes (or dimethicones) containing alkyl, alkoxy or phenyl groups, during or at the end of the silicone chain, groups containing from 2 to 24 carbon atoms; phenylsilicones such as phenyltrimethicones, phenyldimethicones, phenyltrimethylsiloxydiphenylsiloxanes, diphenyldimethicones and diphenylmethyldiphenyltrisiloxanes, 2-phenylethyltrimethyl siloxysilicates, and polymethylphenylsiloxanes;
fatty alcohols with 8 to 26 carbon atoms, such as cetyl alcohol, stearyl alcohol and the mixture (cetyl stearyl alcohol) thereof, or else octyldodecanol;
partially hydrocarbon-based and/or silicone-based fluorinated oils such as same described in document JP-A-2-295912;
and mixtures thereof.

In a preferred embodiment, the oil is selected from the group consisting of isononyl isononanoate, dimethicone, isohexadecane, polydimethylsiloxane, octyldodecanol, isodecyl neopentanoate and mixtures thereof.

Advantageously, a dispersion according to the invention comprises at least one non-volatile hydrocarbon oil containing more than 90%, preferably more than 95%, of fatty acids with chain lengths greater than or equal to 18 carbon atoms, preferably greater than or equal to 20 carbon atoms, more particularly comprised between C18 and C36, preferably between C20 and C28, and better between C20 and C22 (oil H1).

“Non-volatile” refers to an oil the vapor pressure of which at ambient temperature and atmospheric pressure is non-zero and less than 0.02 mm Hg (2.66 Pa) and better less than 10-3 mm Hg (0.13 Pa).

Thereby, as H1 oils, mention can be made of jojoba oil, linseed oil, Perilla oil, Inca Inchi oil, rosehip oil, rapeseed oil, hemp oil, sweet almond oil, corn oil, apricot oil, castor oil, Meadowfoam oil (INCI: Limnanthes Alba (Meadowfoam) Seed Oil) and mixtures thereof, preferably jojoba oil and/or Meadowfoam oil, and better Meadowfoam oil.

According to another preferred embodiment, the fatty phase does not comprise any silicone oil, and preferably does not comprise any polydimethylsiloxane (PDMS).

A person skilled in the art would be able to adjust the nature and/or the content of oil(s), in particular to provide satisfactory kinetic stability of the dispersion according to the invention and to preserve the aforementioned advantageous technical effects.

A dispersion according to the invention may comprise between 0% and 100%, more particularly between 1% and 99.49%, preferably between 20% and 90%, and more particularly between 30% and 60%, by weight of oil(s) relative to the total weight of the fatty phase.

### Continuous Phase

As indicated hereinabove, a dispersion according to the invention comprises a continuous phase, said continuous phase being aqueous or oily, preferably aqueous.

Preferably, the continuous phase is in liquid form at ambient temperature and atmospheric pressure. In other words, the continuous phase is not solid at ambient temperature and at ambient pressure.

Advantageously, the continuous phase is provided with a viscosity suitable for providing the suspension (or ability of suspension) of the drops over a period of time greater than or equal to 1 month, preferably greater than or equal to 3 months, better greater than or equal to 6 months, and most particularly greater than or equal to 12 months. In addition to the associated visual aspect, the suspensive character serves to prevent/limit the phenomena of coalescence of the drops with one another and/or creaming and/or sedimentation of the drops in the continuous phase, and to prevent the risk of inhomogeneity in the distribution of the reflective particles and hence to prevent any alteration of the visual appearance of a dispersion according to the invention.

A person skilled in the art would be able to adjust the viscosity and/or the nature of the continuous phase to ensure the ability of suspension of the drops of dispersed phase in the continuous phase.

More particularly, at ambient temperature and atmospheric pressure, the continuous liquid phase of a dispersion according to the invention has a viscosity as measured at 25° C., comprised between 1 mPa·s and 5,000 mPa·s, preferably from 10 mPa·s to 4,000 mPa·s, in particular from 100 mPa·s to 3,000 mPa·s, more particularly from 200 mPa·s to 1,500 mPa·s.

The viscosity is measured at ambient temperature and at ambient pressure, by the method described in WO2017046305.

### Dispersed Phase

The dispersed phase and the continuous phase are immiscible with one another at ambient temperature and atmospheric pressure.

According to a first variant, the dispersed phase is an oily phase and the continuous phase is an aqueous phase.

According to a second variant, the dispersed phase is an aqueous phase and the continuous phase is an oily phase.

According to a third variant, the dispersed phase and the continuous phase are both oily phases which are immiscible with one another at ambient temperature and atmospheric pressure. “Immiscible oils”, as defined by the present invention, means that the mixture of the two oils does not lead to a homogeneous single-phase solution. A person skilled in the art would be able to adjust the choice of oils to satisfy the abovementioned “immiscible” criterion. Oils immiscible with one another are described in particular in FR1752204, the content of which is incorporated by reference.

A dispersion according to the invention may comprise from 0.5% to 80%, preferably from 1% to 70%, better from 2.5% to 60%, more particularly from 5% to 50%, preferably 7.5% to 40%, better from 10% to 30%, and most particularly from 15% to 20%, by weight of dispersed phase relative to the total weight of the dispersion.

The dispersed phase of a dispersion according to the invention is in the form of macroscopic drops, i.e. visible to the naked eye. Thereby, in a dispersion according to the invention, the constituent phases thereof form a macroscopically inhomogeneous mixture.

Furthermore, the drops advantageously have an apparent monodispersity (i.e. same are perceived by the eye as spheres identical in diameter). The droplets are advantageously substantially spherical.

Advantageously, a method according to the invention is intended to form single or multiple dispersions wherein the drops have a diameter greater than or equal to 100 microns, more particularly greater than or equal to 250 microns, preferably greater than or equal to 500 microns, and in particular comprised between 250 microns and 3000 microns, preferably between 500 microns and 2000 microns, even between 750 microns and 1500 microns.

According to a particular embodiment, a method according to the invention is intended to form a single final dispersion based on a transient formation step of a multiple dispersion, as described in greater detail hereinafter

More particularly, the dispersion according to the invention is intended to form dispersions wherein the drops having a diameter greater than or equal to 100 μm represent a volume greater than or equal to 60%, or even greater than or equal to 70%, preferably greater than or equal to 80%, and better greater than or equal to 90% of the total volume of the dispersed phase and/or at least 60%, even at least 70%, preferably at least 80% and better at least 90%, of the droplets have a mean diameter greater than or equal to 100 μm. Preferably, the diameter is greater than or equal to 150 μm, better greater than or equal to 200 μm, more particularly greater than or equal to 250 μm, preferably greater than or equal to 300 μm, more particularly greater than or equal to 400 μm and better greater than or equal to 500 μm.

Preferably, the dispersions of the invention consist of a population of monodispersed droplets, in particular such that same have a mean diameter D comprised between 100 μm to 3,000 μm, more particularly from 500 μm to 3,000 μm and a coefficient of variation Cv of less than 10%, or even less than 3%.

Within the framework of the present description, “monodispersed droplets” refer to the fact that the population of droplets of the dispersion according to the invention has a uniform size distribution. Monodisperse droplets exhibit good monodispersity. On the other hand, droplets exhibiting poor monodispersity are called “polydispersed”.

According to one embodiment, the mean diameter D of the droplets is measured, e.g., by analyzing a photograph of a batch consisting of N droplets, by image processing software (Image J). Typically, according to such method, the diameter is measured in pixels, then related to μm, as a function of the size of the container containing the droplets of the dispersion.

Preferably, the value of N is chosen to be greater than or equal to 30, so that such analysis reflects statistically significantly, the distribution of diameters of the droplets of said emulsion. N is advantageously greater than or equal to 100, in particular in the case where the dispersion is polydispersed.

The diameter Di of each droplet is measured, then the mean diameter is obtained D̅ by calculating the arithmetic mean of the values:

$$\overline{D} = \frac{1}{N} {\sum }_{i = 1}^{N} {D}_{i}$$

From the Di values, the standard deviation σ of the diameters of the droplets of the dispersion can be also obtained:

$$σ = \sqrt{\frac{{\sum }_{i = 1}^{N} {( {D}_{i} - \overline{D} )}^{2}}{N}}$$

The standard deviation σ of a dispersion reflects the distribution of the diameters Di of the droplets of the dispersion around the mean diameter D̅.

By knowing the mean diameter D̅ and the standard deviation of σ a dispersion, it can be determined that 95.4% of the droplet population is found in the interval of diameters [D̅−2σ;D̅+2σ] and 68.2% of the population is found in the interval [D̅−σ;D̅+σ].

To characterize the monodispersity of the dispersion according to said embodiment of invention, the coefficient of variation can be calculated:

$${C}_{v} = \frac{σ}{\overline{D}}$$

Such parameter reflects the distribution of the diameters of the droplets according to the mean diameter of the latter.

The coefficient of variation Cv of the diameters of the droplets according to said embodiment of the invention is less than 10%, preferably less than 5%, or even less than 3%.

Alternatively, the monodispersity can be demonstrated by placing a dispersion sample in a bottle with a constant circular cross-section. Gentle stirring by a quarter-turn rotation of the bottle in one half-second about the axis of symmetry passing through the bottle, followed by a rest time of one half-second is performed before repeating the operation in the opposite direction, the whole operation being repeated four successive times.

The droplets of the dispersed phase organize in a crystalline form when the droplets are monodispersed. Thereby, the droplets are stacked in a pattern repeating in three dimensions. It is then possible to observe a regular stacking which indicates a good monodispersity, an irregular stacking reflecting the polydispersity of the dispersion.

To obtain monodisperse drops, the microfluidic technique can also be used (Utada et al. MRS Bulletin 32, 702-708 (2007); Cramer et al. Chem. Eng. Sci. 59, 15, 3045-3058 (2004)), and more particularly microfluidic devices of the co-flow type (the fluids go in the same direction) or flow-focusing type (the fluids go in different directions, and typically in opposite directions).

The drops of a dispersion according to the present invention may be chosen from solid or matrix particles, particles of core/shell type (also referred to by the term “capsule”), and the mixture thereof.

Drops can be monophasic or multiphasic. For example, the drops comprise a core (which comprises at least one phase), optionally a shell (or envelope or membrane) totally encapsulating the core, where the core as such can comprise one or a plurality of phases.

According to a first embodiment, a drop according to the invention is a solid (or monophasic) particle. The solid drops include particles containing at least one gelled polyelectrolyte, e.g. containing alginate and/or at least one polymer, e.g. Estogel M from PolymerExpert (INCI: CASTOR OIL/IPDI COPOLYMER & CAPRYLIC/CAPRIC TRIGLYCERIDE), preferably a thermosensitive polymer, e.g. agar-agar or RheoPearl KL2 (INCI: dextrin palmitate), and mixtures thereof.

According to a second embodiment, a drop according to the invention is a core/shell particle. A core/shell drop is a capsule which comprises a core, preferably liquid or at least partially gelled or at least partially thixotropic, and a shell, completely encapsulating said core, said core being monophasic, and more particularly containing a phase immiscible with the continuous phase at ambient temperature and atmospheric pressure.

Such a type of drop then corresponds to a single capsule comprising:
two distinct phases, an inner phase, preferably liquid or at least partly gelled or at least partly thixotropic, forming the core and an outer phase surrounding the inner phase and forming the shell; or
a single phase completely surrounded by a shell resulting e.g. from a coacervation reaction as described hereinafter.

A solid pearl drop or a core/shell drop (also referred to as drop (G1)) is illustrated in FIG. 2.

A drop may also be a solid or core/shell particle including an intermediate drop (G1) of an intermediate phase (or third phase 19), the intermediate phase being placed in contact with the continuous phase or the shell (when present), and at least one, preferably a single, internal drop (G2) of an inner phase arranged in the intermediate drop. Such a complex drop is illustrated in FIG. 4.

The intermediate phase is e.g. produced on the basis of a solution immiscible with the inner phase at ambient temperature and atmospheric pressure. As an illustration, when the intermediate phase is aqueous, the inner phase is oily, and conversely, when the intermediate phase is oily, the inner phase is aqueous.

According to one variant, a drop comprises an intermediate phase within which are located a plurality of drops of inner phase(s).

Advantageously, the intermediate phase comprises at least one gelling agent, in particular as defined hereinbelow. The gelling agent contributes in particular to improving the suspension of the internal drop(s) arranged in the intermediate drop according to such embodiment and prevents the phenomena of creaming or sedimentation of the internal drop(s) arranged in the intermediate drop.

According to a particular embodiment, the complex drop structure described hereinabove is transient and suitable for the manufacture of single core/shell drops stabilized by a coacervate derived from the reaction between a first precursor polymer of the coacervate present in the first phase and a second precursor polymer of the coacervate present in the second phase and wherein the first phase comprises little or no gelling agent. In such embodiment, the intermediate phase (or third phase 19) is miscible with the inner phase. The third phase is dedicated to merging with the first phase during and/or after formation of the drops 12. Herein, the role thereof is to prevent any premature reaction between the two precursor polymers of the coacervate that could block/alter the manufacturing method. Said embodiment is described in greater detail in WO2012120043.

Preferably, the dispersed phase is transparent or at least translucent. The transparency or translucency property of the dispersed phase is determined as follows: the composition to be tested (30 ml) is poured into a 30 ml Volga jar, the composition is left for 24 hours at ambient temperature and a white sheet is placed beneath, on which a cross approximately 2 mm thick is drawn with a black felt tip pen. If the cross is visible to the naked eye in daylight at an observation distance of 40 cm, the composition is transparent or translucent.

According to one particular embodiment:
the continuous phase may as such be in the form of a direct or invert emulsion, the size of the drops (G3) preferably being smaller than the size of the drops (G1), or even of the drops (G2); and/or
the dispersed phase, or even the intermediate phase and/or the inner phase in the case of a multiple dispersion (or complex drop) as defined hereinabove, may be in the form of a direct or invert emulsion comprising drops (G4) and/or (G5), the size of the drops (G4) and/or (G5) being necessarily smaller than the size of the drops (G1), or even of the drops (G2).

The drops (G3) and/or (G4) and/or (G5) are preferably microscopic, i.e. not visible to the naked eye and in particular of a size less than 100 μm, preferably less than 20 μm and better less than 10 μm.

Optionally, the drops (G3) and/or (G4) and/or (G5) comprise a shell, preferably formed of at least one anionic polymer, more particularly a carbomer, and of at least one cationic polymer, more particularly an amodimethicone, as defined hereinbelow.

In other words, the drops (G3) and/or (G4) and/or (G5) are different and independent from the drops (G1), or even of the drops (G2).

### Drop Shell

According to a first embodiment, the droplets of a dispersion according to the invention are devoid of any shell, more particularly of a polymeric membrane or a membrane formed by interfacial polymerization. More particularly, the droplets of a dispersion according to the invention are not stabilized using a coacervate (such as anionic polymer (carbomer)/cationic polymer (amodimethicone)) membrane. In other words, the contact between the continuous phase and the dispersed phase is direct.

According to another embodiment, the drops of the dispersed phase further comprise a shell. The shell can be as defined in WO2015166454.

According to a first variant, the shell completely encapsulating the core typically contains at least one gelled polyelectrolyte and/or at least one polymer, preferably a thermosensitive polymer, e.g. agar-agar.

According to another preferred variant, the drops according to the invention are surrounded by a shell comprising at least one anionic polymer and at least one cationic polymer.

According to the invention, the drops obtained may have a very fine shell, in particular of thickness less than 1% of the diameter of the drops.

The thickness of the shell is thereby preferably less than 1 μm and is thus too small to be measured by optical methods.

According to one embodiment, the thickness of the shell of the drops is less than 1,000 nm, in particular comprised between 1 and 500 nm, preferably less than 100 nm, advantageously less than 50 nm, preferably less than 10 nm.

The measurement of the thickness of the shell of the drops of the invention can be carried out by the small-angle neutron scattering method, (Small Angle X-Ray Scattering as used in Sato et al. J. Chem. Phys. 111, 1393-1401 (2007).

To this end, the drops are produced using deuterated water, then washed three times with a deuterated oil, such as e.g. a deuterated hydrocarbon oil (octane, dodecane, hexadecane).

After washing, the drops are then transferred into the Neutron cell to determine the spectrum I(q); q being the wave vector.

From the spectrum, classical analytical treatments (REF) are applied to determine the thickness of the hydrogenated (non-deuterated) shell.

According to one embodiment, the shell surrounding the drops of the dispersed phase is rigidified, which in particular imparts a good resistance to the drops and reduces, or even prevents, the coalescence thereof.

The shell is typically formed by coacervation, i.e. by precipitation of polymers charged with opposite charges. Within a coacervate, the bonds that bind the charged polymers together are ionic bonds, and are generally stronger than bonds present within a surfactant membrane.

The shell is formed by coacervation of at least two charged polymers of opposite polarity (or polyelectrolyte) and preferably in the presence of a first precursor polymer of the coacervate, of cationic type, and of a second precursor polymer of the coacervate, different from the first polymer, of anionic type. The two polymers act as membrane rigidifying agents.

The formation of the coacervate between the two polymers can be brought about by a modification of the conditions of the reaction medium (temperature, pH, concentration of reactants, etc.).

The coacervation reaction results from the neutralization of the two charged polymers of opposite polarities and makes possible the formation of a membrane structure by electrostatic interactions between the anionic polymer and the cationic polymer. The membrane thereby formed around each drop typically forms a shell which completely encapsulates the core of the drop, and thereby isolates the core of the drop from the continuous aqueous phase.

The anionic and cationic polymers are in particular different from the oils described hereinabove and from the gelling agents described hereinafter.

### Anionic Polymer

Within the framework of the present description, “polymer of anionic type” or “anionic polymer” refers to a polymer including chemical functions of anionic type. It is also possible to speak of anionic polyelectrolyte.

“Chemical function of anionic type” refers to a chemical function AH apt to transfer a proton to lead to an A function. Depending on the conditions of the medium in which same is found, the anionic polymer thus includes chemical functions in the form AH, or else in the form of the conjugated base thereof, A⁻.

As an example of chemical functions of anionic type, mention may be made of carboxylic acid functions —COOH, possibly present in the form of carboxylate anion —COO⁻.

As an example of a polymer of anionic type, mention may be made of any polymer formed by the polymerization of monomers, at least a portion of which carries chemical functions of anionic type, such as carboxylic acid functions. Such monomers are e.g. acrylic acid, maleic acid, or any ethylenically unsaturated monomer including at least one carboxylic acid function. Such monomer may be e.g. an anionic polymer comprising monomer units including at least one chemical function of carboxylic acid type.

Preferably, the anionic polymer is hydrophilic, i.e. soluble or dispersible in water.

Among the examples of polymers of anionic type suitable for using the invention, mention may be made of copolymers of acrylic acid or of maleic acid and other monomers, such as acrylamide, alkyl acrylates and C₅-C₈ alkyl acrylates, C₁₀-C₃₀ alkyl acrylates, C₁₂-C₂₂ alkyl methacrylates, methoxypolyethylene glycol methacrylates, hydroxyester acrylates, crosspolymer acrylates, and mixtures thereof.

According to the invention, a polymer of anionic type is preferably a carbomer as described hereinafter. The polymer may also be a crosslinked acrylate/C₁₀₋₃₀ alkyl acrylate copolymer (INCI name: acrylates/C₁₀₋₃₀ alkyl acrylate Crosspolymer).

According to one embodiment, the shell of the drops comprises at least one anionic polymer, such as e.g. a carbomer.

Within the framework of the invention, and unless otherwise mentioned, “carbomer” refers to an optionally crosslinked homopolymer derived from the polymerization of acrylic acid. It thus concern a poly(acrylic acid), cross-linked if appropriate. Among the carbomers of the invention, mention may be made of the carbomers marketed under the names Tego® Carbomer 340FD from Evonik, Carbopol® 981 from Lubrizol, Carbopol ETD 2050 from Lubrizol, or else Carbopol Ulterol 10 from Lubrizol.

According to one embodiment, “carbomer” or “Carbopol®” refers to a high molecular weight acrylic acid polymer crosslinked with allylic sucrose or allylic ethers of pentaerythritol (handbook of Pharmaceutical excipients, 5^{th} Edition, pIII). For example, same are Carbopol®910, Carbopol®934, Carbopol®934P, Carbopol®940, Carbopol®941, Carbopol®71G, Carbopol®980, Carbopol®971P or Carbopol®974P from Lubrizol. Mention may also be made of Carbopol® clear Polymer from Lubrizol. According to one embodiment, the viscosity of said carbomer is comprised between 4,000 and 60,000 CP at 0.5% w/w

The carbomers have other names: polyacrylic acids, carboxyvinyl polymers or carboxy polyethylenes.

A dispersion according to the invention may comprise from 0.01% to 5% by weight, preferably from 0.05% to 2%, and preferentially from 0.10% to 0.5% of anionic polymer(s), in particular carbomers, with respect to the weight of the phase comprising same, even with respect to the total weight of the dispersion.

### Cationic Polymer

Within the framework of the present application, and unless otherwise mentioned, “polymer of cationic type” or “cationic polymer” refers to a polymer including chemical functions of cationic type. It is also possible to speak of a cationic polyelectrolyte.

Preferably, the cationic polymer is lipophilic or liposoluble.

Within the framework of the present application, and unless otherwise mentioned, “chemical function of cationic type” refers to a chemical function B apt to capturing a proton to lead to a function BH⁺. Depending on the conditions of the medium wherein is found, the cationic polymer thus includes chemical functions in the B form, or else in the BH⁺ form, the conjugated acid thereof.

As examples of chemical functions of cationic type, mention may be made of primary, secondary and tertiary amine functions, present, if appropriate, in the form of ammonium cations.

As an example of a polymer of cationic type, mention may be made of any polymer formed by the polymerization of monomers, at least a portion of which carries chemical functional groups of cationic type, such as primary, secondary or tertiary amine functions.

Such monomers are, e.g., aziridine, or any ethylenically unsaturated monomer comprising at least one primary, secondary or tertiary amine function.

Among the examples of cationic polymers suitable for the use of the invention, mention may be made of amodimethicone, derived from a silicone polymer (polydimethylsiloxane, also called dimethicone), modified by primary amine and secondary amine functions.

Mention may also be made of amodimethicone derivatives, such as e.g. amodimethicone copolymers, aminopropyl dimethicone, and more generally linear or branched silicone polymers including amine functions.

Mention may be made of bis-isobutyl PEG-14/amodimethicone copolymer, bis(C13-15 alkoxy) PG-amodimethicone, bis-cetearyl amodimethicone and bis-hydroxy/methoxy amodimethicone.

Mention may also be made of polysaccharide polymers comprising amine functions, such as chitosan or derivatives of guar gum (hydroxypropyltrimonium chloride guar).

Mention may also be made of polypeptide polymers comprising amine functions, such as polylysine.

Mention may also be made of polyethyleneimine polymers comprising amine functions, such as linear or branched polyethyleneimine.

According to one embodiment, the cationic polymer is a silicone polymer modified by a primary, secondary or tertiary amine function, such as amodimethicone.

According to one embodiment, the drops, and more particularly the shell of said drops, comprise amodimethicone.

According to one embodiment particularly preferred embodiment, the polymer has the following formula:

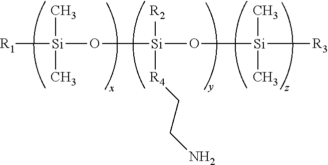

wherein:
R₁, R₂ and R₃, independently of each other, represent OH or CH₃;
R₄ represents a group —CH₂— or a group —X—NH— wherein X is a C₃ or C₄ divalent alkylene radical;
x is an integer comprised between 10 and 5,000, preferably between 30 and 1,000, and better between 80 and 300;
y an integer comprised between 1 and 1,000, preferably between 2 and 100, and better between 2 and 20; and
z is an integer comprised between 0 and 10, preferably between 0 and 1, and better is equal to 1.

In the abovementioned formula, when R₄ represents an —X—NH— group, X is bonded to the silicon atom.

In the abovementioned formula, R₁, R₂ and R₃ preferably represent CH₃.

In the abovementioned formula, R₄ is preferably a —(CH₂)₃—NH— group.

According to the invention, the dispersion may comprise from 0.01% to 10%, preferably from 0.05% to 5%, by weight of cationic polymer(s), in particular amodimethicone(s), relative to the weight of the phase comprising same.

Solution Comprising at Least One Raw Material which is not Compatible or not Very Compatible with the Microfluidic Emulsification Step (i) and/or the Flow (AF) Step (ii)

As defined by the present invention, the raw materials which are not compatible or not very compatible with the microfluidic emulsification step (i) and/or the flow step (ii) are present in continuous phase, and thus in the second phase 16 after recovery of the dispersion.

“Acidic pH”, as defined by the present invention, refers to a pH of the second phase, comprised between 3.5 and 5.5, and preferably between 4 and 5.

Given the technical problems listed hereinabove, the non-compatible or slightly compatible raw materials may be chosen from among reflective particles, a raw material apt to form a precipitate, a raw material apt to increase the pH of the second phase, a raw material sensitive to acidic pH, a raw material apt to modify the surface tension of the second phase, and mixtures thereof, being understood that such a raw material may belong to one or more of the aforementioned classes.

An additional solution is different from a solution for increasing the viscosity of the second phase as described in WO2015055748.

### Reflective Particles

“Reflective particles”, as defined by the present invention, refer to particles having a size, structure, in particular the thickness of the layer or layers forming same and a physical and chemical nature, and a surface state, enable the particles to reflect incident light. The reflection may, where appropriate, have an intensity sufficient to create on the surface of the dispersion according to the invention, when the latter is applied in particular to a keratin material, highlighted points visible to the naked eye, i.e. brighter spots that contrast with the surroundings thereof by appearing to shine.

Within the framework of the present invention, the abovementioned reflective particles can be referred to indistinctly by the term “flakes”.

As can be seen from example . . . , flakes, when present in the second phase at acidic pH before the emulsification step, lead to blockages of the microfluidic device such that the manufacture of a dispersion according to the invention is impossible.

According to a particular embodiment, the reflective particles have a ratio “d/e” greater than 10, where “d” represents the largest dimension of the reflective particles and “e” represents the thickness of the reflective particles. Preferably, the ratio between the largest dimension and the thickness of the reflective particles “d/e” is greater than or equal to 10, more particularly greater than or equal to 20, and better greater than or equal to 50.

The reflective particles, whatever the shape thereof, may have a size comprised between 5 and 1,000 μm, more preferentially between 10 and 750 μm, more particularly between 50 and 500 μm, and better between 100 and 250 μm. The size of the particles is preferably greater than or equal to 10 μm, better greater than or equal to 20 μm, better still greater than or equal to 40 μm.

Where a dispersion according to the invention further comprises at least one continuous phase coloring agent, the reflective particles are advantageously selected so as not to significantly alter the coloring effect generated by the associated coloring agent and more particularly so as to optimize the effect in terms of color rendering.

The reflective particles may more particularly have a yellow, pink, red, bronze, orangey, brown, gold and/or copper color or shimmer.

The reflective particles may have various shapes. The particles may be in particular platelet-shaped or globular, more particularly spherical. The reflective particles, whatever the shape thereof, may or may not have a multilayer structure and, in the case of a multilayer structure, e.g. at least one layer of uniform thickness, in particular of a reflective material.

When the reflective particles do not have a multilayer structure, same may be composed e.g. of metal oxides, e.g. titanium or iron oxides obtained by synthesis.

When the reflective particles have a multilayer structure, same may e.g. comprise a natural or synthetic substrate, in particular a synthetic substrate at least partially coated with at least one layer of a reflective material, in particular of at least one metal or metal compound. The substrate may be single-material, multimaterial, organic and/or inorganic.

More particularly, same may be chosen amongst glasses, ceramics, graphite, metal oxides, aluminas, silicas, silicates, in particular aluminosilicates and borosilicates, synthetic mica and mixtures thereof, the list not being limiting.

The reflective material may include a layer of metal or a metal compound.

Glass particles covered with a metal layer are described in particular in documents JP-A-09188830, JP-A-10158450, JP-A-10158541, JP-A-07258460 and JP-A-05017710.

Still as an example of reflective particles comprising a mineral substrate coated with a metal layer, mention may further be made of particles comprising a borosilicate substrate coated with silver, also known as “white pearlizers”.

Particles with a silver-coated glass substrate, in the form of platelets, are sold by TOYAL under the name MICROGLASS Metashim REFSX 2025 PS. Particles with a glass substrate coated with nickel/chromium/molybdenum alloy are sold by the same company under the name CRYSTAL star GF 550, GF 2525.

The reflective particles, whatever the shape thereof, may also be chosen from particles with a synthetic substrate coated at least partially with at least one layer of at least one metal compound, in particular a metal oxide, chosen e.g. from titanium oxides, in particular TiO2, iron oxides, in particular Fe2O3, tin oxides, etc. chromium, barium sulfate and the following compounds: MgF2, CrF3, ZnS, ZnSe, SiO2, Al2O3, MgO, Y2O3, SeO3, SIO, HfO2, ZrO2, CeO2, Nb2O5, Ta2O5, MoS2 and mixtures or alloys thereof.

Examples of such particles include particles including a synthetic mica substrate coated with titanium dioxide, or glass particles coated with brown iron oxide, titanium oxide, etc. tin oxide or a mixture thereof, such as same sold by ENGELHARD under the trademark Reflecks®.

The reflective particles may or may not be goniochromatic and/or may or may not be interferential.

The reflective particles may be chosen from pearlizers, reflective interferential particles, goniochromatic (coloring) agents, diffractive pigments, and mixtures thereof.

“Pearlizers” refer to colored particles of any shape, iridescent or non-iridescent, in particular produced by certain mollusks in the shell thereof or else synthesized and which exhibit a color effect by optical interference.

The pearlizers may be chosen from pearlescent pigments such as titanium mica coated with an iron oxide, mica coated with bismuth oxychloride, titanium mica coated with chromium oxide, titanium mica coated with an organic dye, in particular of the aforementioned type, as well as pearlescent pigments containing bismuth oxychloride. Same may also be mica particles on the surface of which are superposed at least two successive layers of metal oxides and/or organic coloring materials.

More particularly, the pearlizers may have a yellow, pink, red, bronze, orangey, brown, gold and/or copper color or shimmer.

As an illustration of the pearlizers which can be used within the framework of the present invention, mention may be made in particular of the gold pearlizers marketed by ENGELHARD under the name Brillant gold 212G (Timica), Gold 222C (cloisonne), Sparkle gold (Timica), Gold 4504 (Chromalite) and Monarch gold 233X (Cloisonne); bronze pearlizers marketed in particular by MERCK under the name Bronze fine (17384) (Colorona) and Bronze (17353) (Colorona) and by ENGELHARD under the name Super bronze (Cloisonne); orange pearlizers marketed in particular by ENGELHARD under the name Orange 363C (Cloisonne) and Orange MCR 101 (Cosmica) and by MERCK under the name Passion Orange (Colorona) and Matte Orange (17449) (Microna); brown-shade pearlizers marketed in particular by ENGELHARD under the name Nu-antique copper 340XB (Cloisonne) and Brown CL4509 (Chromalite); copper-shimmer pearlizers marketed in particular by ENGELHARD under the name Copper 340A (Timica); red-shimmer pearlizers marketed in particular by MERCK under the name Sienna fine (17386) (Colorona); yellow-shimmer pearlizers marketed in particular by ENGELHARD under the name Yellow (4502) (Chromalite); the red-shade gold-shimmer pearlizers marketed in particular by the company ENGELHARD under the name Sunstone G012 (Gemtone); pink pearlizers marketed in particular by the company ENGELHARD under the name Tan opale G005 (Gemtone); gold-shimmer black pearlizers marketed in particular by ENGELHARD under the name Nu antique bronze 240 AB (Timica), blue pearlizers marketed in particular by MERCK under the name Matte blue (17433) (Microna), silver-shimmer white pearlizers marketed in particular by the company MERCK under the name XIRONA Silver and the golden green orangey pinky pearlizers marketed in particular by the company MERCK under the name Indian summer (XIRONA), and mixtures thereof.

Mention may also be made of reflective interferential particles containing glass such as Ronastar marketed by MERCK or synthetic interferential particles containing mica such as Sunshine marketed by SUN CHEMICAL or PROMINENCE marketed by NIKON KOKEN, and mixtures thereof.

It is also possible to envisage using a goniochromatic coloring agent as reflective particles, provided that said agent satisfies the requirement of a shade effect required according to the invention and does not, moreover, change the visual perception of the composition in terms of a color effect. The goniochromatic coloring agent may be chosen in particular from interferential multilayer structures.

The goniochromatic pigment may e.g. be chosen from multilayer interference structures, liquid crystal coloring agents, and mixtures thereof.

As an example, a multilayer structure may comprise at least two layers, each layer being made e.g. of at least one material selected from the group consisting of the following materials: MgF2, CeF3, ZnS, ZnSe, SI, SiO2, Ge, Te, Fe2O3, Pi, Va, Al2O3, MgO, Y2O3, S203, SIO, HfO2, ZrO2, CeO2, Nb2O5, Ta2O5, TiO2, Ag, Al, Au, Cu, Rb, Ti, Ta, W, Zn, MoS2, cryolite, alloys, polymers and combinations thereof.

The multilayer structure may optionally be symmetrical with respect to a central layer with regard to the chemical nature of the stacked layers.

Different effects are obtained depending on the thickness and the nature of the different layers.

Examples of pigments having such structures are marketed by MERCK (Darmstadt) under the trade name XIRONA.

As an example, the liquid crystal coloring agents comprise silicones or cellulose ethers onto which mesomorphic groups have been grafted. Examples of suitable liquid crystalline goniochromatic particles are same sold by CHENTX, and same sold by WACKER under the trade name HELICONER HC. Suitable goniochromatic pigments are pearlizers; pigments having effects on synthetic substrates, more particularly alumina, silica, borosilicate, iron oxide or aluminum substrates; or interference particles coming from a polyterephthalate film.

The material may further contain dispersed goniochromatic fibers. Such fibers could have a length e.g. of less than 80 μm.

The term “diffractive pigment” as used in the present invention refers to a pigment which is apt to produce a variation in color depending on the angle of observation when illuminated by white light due to the presence of a structure which diffracts the light.

Such a pigment is sometimes called holographic pigment or rainbow effect pigment.

A diffractive pigment may include a diffraction matrix apt e.g. to diffract an incident ray of monochromatic light in predetermined directions.

The diffraction matrix may comprise a periodic pattern, in particular a line, the distance between two adjacent patterns being of the same order of magnitude as the wavelength of the incident light.

When the incident light is polychromatic, the diffraction matrix separates the different spectral components of the light and produces a rainbow effect. As regards the structure of the diffractive pigments, reference may be made to the article “Pigments Exhibiting Diffractive Effects” by Alberto Argoitia and Matt Witzman, 2002, Society of Vacuum Coaters, 45th Annual Technical Conference proceedings, 2002, the content of which is incorporated herein by reference.

The diffractive pigment may be produced with patterns of different profiles, in particular triangular, symmetrical or asymmetrical, crenelated, of constant or non-constant width, sinusoidal or stepped.

The spatial frequency of the matrix and the depth of the pattern will be chosen depending upon the desired degree of separation of the different orders. As an example, the frequency may be comprised between 500 and 3000 lines per mm.

Preferably, the diffractive pigment particles each have a flattened shape, more particularly in the form of a platelet. The same pigment particle may comprise two crossed diffraction matrices, either perpendicular or not perpendicular, and having the same spacing or a different spacing.

The diffractive pigment may have a multilayer structure comprising a layer of reflective material, covered on at least one side by a layer of dielectric material. The layer can give the diffractive pigment improved rigidity and durability. Thereby, the dielectric material may e.g. be chosen from among the following materials: MgF2, SiO2, Al2O3, AlF3, CeF3, LaF3, NdF3, SmF2, BaF2, CaF2, LiF, and combinations thereof.

The reflective material may, e.g., be chosen from metals and the alloys thereof as well as from non-metallic reflective materials. Metals that can be mentioned include Al, Ag, Cu, Au, Pt, Sn, Ti, Pd, Ni, Co, Rd, Nb, Cr, and materials, combinations or alloys thereof. Such a reflective material may alone form the diffractive pigment which is then a monolayer.

In a variant, the diffractive pigment may comprise a multilayer structure comprising a substrate made of a dielectric material covered on at least one face by a reflective layer, or even completely encapsulating the substrate.

A layer of a dielectric material may also cover the reflective layer or layers. The dielectric material used is thereby preferably inorganic and may e.g. be chosen from metal fluorides, metal oxides, metal sulfides, metal nitrides, metal carbides and combinations thereof. The dielectric material may be in the crystalline, semi-crystalline or amorphous state. The dielectric material in such configuration may e.g. be chosen from the following materials: MgF2, SiO, Si02, Al203) Ti02, WO, AlN, BN, B4C, WC, TIC, TIN, N4Si3, ZnS, glass particles, diamond carbons of the type and combinations thereof. In a variant, the diffractive pigment may be composed of a dielectric or preformed ceramic material such as a mineral in natural lamellae, e.g. peroskovite mica or talc, or synthetic lamellae formed of glass, alumina, Si02, carbon, iron oxide/mica, of BN-coated mica, BC-coated mica, graphite-coated mica, of bismuth oxychloride and combinations thereof.

Instead of a layer of a dielectric material, other materials that improve the mechanical properties may be suitable. Such materials may comprise silicone, metal silicides, semiconductor materials formed from Group III, IV, and V elements, metals having a centered cubic crystal structure, Cermet compositions or materials, semiconductor glasses, and various combinations thereof. The diffractive pigment used may in particular be chosen from same described in patent application US-2003/0031870 published on 13 Feb. 2003. A diffractive pigment may e.g. comprise the following structure: MgF2/Al/MgF2, a diffractive pigment having such structure being marketed by Flex PRODUCTS under the trade name SpectraFLAIR 1400 Pigment Silver or SpectrFLAIR 1400 Pigment Silver FG. The proportion by weight of MgF2 may be comprised between 80% and 95% of the total weight of the pigment. Other diffractive pigments are sold by ECKART® under the trade names Metalure® PRISMATIC.

Other possible structures are Fe/Al/Fe or Al/Fe/Al.

The dimension of the diffractive pigment may e.g. be comprised between 5 and 200 μm, better between 5 and 100 μm, e.g. between 5 and 30 μm. The thickness of the diffractive pigment particles may be 3 μm or less, preferably 2 μm, e.g. of the order of 1 μm.

Of course, a person skilled in the art would take care to choose the nature and/or the quantity of reflective particles as a function of the nature of the considered phase of the dispersion according to the invention and/or according to the method for manufacturing of said dispersion. Such adjustments fall within the general knowledge of a person skilled in the art.

Preferably, the reflective particles may be present in a dispersion according to the invention in a concentration ranging from 0.1% to 60% by weight, in particular from 0.25% to 40% by weight, more particularly from 0.5% to 20% by weight, better from 1% to 10% by weight, more particularly from 1.5% to 5% by weight, and most particularly from 2.5% to 5% by weight, relative to the weight of the continuous phase, or even relative to the total weight of the dispersion.

### Raw Material Apt to Form a Precipitate

“Raw material apt to form a precipitate”, as defined by the present invention, refers to a compound which, in the presence of certain conditions and/or in the presence of at least one other compound, leads to the formation of a precipitate.

The formation of the precipitate may result from (i) a molecular aggregation reaction at the raw material with itself (e.g. crystallization), (ii) a reaction between at least two different raw materials or (iii) a reaction of a raw material with one of the constituent elements of the microfluidic device.

As an illustration of raw material apt to form a precipitate by molecular aggregation reaction (e.g. crystallization), mention can be made of the UV filter such as Eusolex 232 (INCI: Phenylbenzimidazole Sulfonic Acid).

As way of illustration of a starting material capable of forming the precipitate by reaction with a constituent element of the microfluidic device, mention may be made of the products sold by the LUBRIZOL company under the trade names a (INCI name=Polyacrylate-2 Crosspolymer), Fixate Freestyle Polymer (INCI name=Acrylates crosspolymer-3), Carbopol® Aqua SF1 (INCI name=Acrylates copolymer) et Carbopol® Aqua SF2 (nom INCI=Acrylates crosspolymer-4) or else same sold by Croda Inc. under the trade name Volarest™ FL. Preferably, the crosslinked polymer or crosslinked copolymer is chosen from Carbopol® Aqua SF1 (INCI name=Acrylates copolymer) and Carbopol® Aqua SF2 (INCI name=Acrylates crosspolymer-4). More particularly, it is Carbopol® Aqua SF1 (INCI name=Acrylates copolymer). More particularly, it is Carbopol® Aqua SF2 (INCI name=Acrylates crosspolymer-4).

As can be seen from example 1, Carbopol® Aqua SF1, when present in the second phase at acidic pH before the emulsification step, leads to phenomena of opacification of the second phase and to the presence of volutes in the second phase, or to even blockages of the line of the second phase of the microfluidic device.

### Raw Material Apt to Increase the pH of the Second Phase

A “raw material apt to increase the pH of the second phase” leads to “activating” the gelling/suspending effect of the carbomer, and thus to an increase in the viscosity of the second phase to values such that the flow of the second phase in the line(s) of the microfluidic device becomes impossible.

Such a raw material may also be referred to as raw material apt to exchange protons.

Preferably, such a raw material is not intrinsically endowed with the gelling property of the second phase. Preferably, such a raw material is not a hydrophilic gelling agent as such.

Such a raw material is necessarily different from a compound chosen from triethanolamine (TEA), sodium hydroxide, potassium hydroxide, and mixtures thereof.

As an illustration of raw material apt to increase the pH of the second phase, mention may be made of Niacinamine (vitamin B3), Natrlquest E30 (INCI: Trisodium Ethylenediamine Disuccinate), la Dragosine (INCI: Carnosine), and mixtures thereof.

As can be seen from example 2, Natrlquest E30, when present in the second phase at acidic pH before the emulsification step, leads to deformation of the drops and/or risks of jetting at the line of the second phase of the microfluidic device, or even to clogging of said line.

### Raw Material Sensitive to Acidic pH

A “raw material sensitive to acidic pH” is a raw material which, at acidic pH, has the properties thereof altered or which induces instability or an undesired change in the composition comprising same.

Such a raw material is necessarily different from the anionic polymer described hereinabove, and in particular from a carbomer.

As an illustration of raw material sensitive to acidic pH, mention may be made of the UV filter such as Eusolex 232 (INCI: Phenylbenzimidazole Sulfonic Acid).

As can be seen from example 3, Eusolex232, when present in the second phase at acidic pH before the emulsification step, leads to an opacification of the second phase.

### Raw Materials Apt to Modify the Surface Tension of the Second Phase

The formation of drops from a first phase into a second phase substantially immiscible with the first phase is governed by a plurality of phenomena, including the Plateau-Rayleigh instability and surface tension.

Thereby, the greater the surface tension between the two phases, the easier the formation of drops. On the other hand, the lower the surface tension between the two phases, the less easy is drop formation.

And yet, certain raw materials can modify the surface tension of the phase comprising same. Compared to a microfluidic method according to the invention, such raw materials are detrimental to the robustness of said method, or even make it impossible to form drops, and hence to manufacture dispersions according to the invention.

Within the meaning of the present invention, a starting material that is not compatible or not very compatible with the microfluidic emulsification step (i) and/or the flow step (ii) is not a surfactant.

More particularly, a raw material apt to modify the surface tension of the second phase is not a surfactant.

As an illustration of raw material apt to modify the surface tension of the second phase within the meaning of the present invention, mention may be made of Biophytex™ LS 9832 from BASF (INCI: Aqua (and) Butylene Glycol (and) Panthenol (and) Escin (and) Glycerin (and) Ruscus Aculeatus Root Extract (and) Ammonium Glycyrrhizate (and) Centella asiatica Extract (and) Hydrolyzed Yeast Protein (and) Calendula officinalis Flower Extract), dermosoft octiol (INCI: Caprylyl Glycol), Matrixyl 3000 (INCI: Glycerin (and) Aqua (and) Butylene Glycol (and) Carbomer (and) Polysorbate 20 (and) Palmitoyl Tripeptide-1 (and) Palmitoyl Tetrapeptide-7), and mixtures thereof.

As can be seen from example 4, Biophytex™ LS 9832, when present in the second phase before the microfluidic emulsification step (i), leads to a non-negligible decrease in the surface tension of the second phase, which makes the formation of drops difficult or even impossible.

Preferably, a dispersion according to the invention may comprise between 0.1% and 60% by weight, in particular between 0.25% and 40% by weight, more particularly between 0.5% and 20% by weight, better between 1% and 10% by weight, more particularly between 1.5% and 5% by weight, and most particularly between 2.5% and 5% by weight, of raw material(s) which are not compatible or not very compatible with the microfluidic emulsification step (i) and/or the flow step (ii), relative to the weight of the continuous phase, or even the total weight of the dispersion.

### Gelling Agent

A dispersion according to the invention, more particularly the continuous phase and/or the dispersed phase and/or the additional solution, may further comprise at least one gelling agent, different from the oils and raw materials which are not compatible or not very compatible with step (i) and/or step (ii) and from the cationic and anionic polymers described hereinabove.

Within the framework of the present invention and unless otherwise mentioned, “gelling agent” refers to an agent which serves to increase the viscosity of the phase comprising same devoid of said gelling agent, and to reach, in particular, a final viscosity of the gelled phase greater than 1,000 mPa·s, preferably greater than 10,000 mPa·s, better greater than 50,000 mPa·s, and most particularly greater than 100,000 mPa·s.

### Hydrophilic Gelling Agent(s)

Within the framework of the description, the term “hydrophilic gelling agent” may be referred to indistinctly by the term “hydrophilic texture agent”. As hydrophilic gelling agents, i.e. soluble or dispersible in water, mention may be made of:
natural gelling agents, in particular chosen from extracts of algae, exudates of plants, extracts of seeds, exudates of microorganisms, such as alcasealan (INCI: Alcaligenes Polysaccharides), and other natural agents, more particularly hyaluronic acid,
semi-synthetic gelling agents, in particular chosen from cellulose derivatives and modified starches,
synthetic gelling agents, in particular chosen from homopolymers of (meth)acrylic acid or one of the esters thereof, copolymers of (meth)acrylic acid or one of the esters thereof, copolymers of AMPS (2-acrylamido-2-methylpropanesulfonic acid), associative polymers,
other gelling agents, chosen in particular from clays, silicas such as same marketed under the names Aerosil® 90/130/150/200/300/380), and
the mixtures thereof.

“Associative polymer”, as defined by the present invention, refers to any amphiphilic polymer comprising in the structure thereof at least one fatty chain and at least one hydrophilic portion; the associative polymers according to the present invention may be anionic, cationic, nonionic or amphoteric; same described in FR 2 999 921 are concerned. Preferably, same are amphiphilic and anionic associative polymers and amphiphilic and nonionic associative polymers as described hereinafter.

The hydrophilic gelling agents are described in more detail in FR3041251.

The presence of a hydrophilic gelling agent in additional solution may be advantageous, so as to ensure a satisfactory suspension of the raw materials apt to settle or cream, more particularly a satisfactory suspension of the reflective particles, before injecting said additional solution into the flow line (38) or at the outlet of the flow line (38), upstream of the container.

### Lipophilic Gelling Agent

A lipophilic gelling agent, i.e. one soluble or dispersible in an oily phase, may be chosen from organic or inorganic, polymeric or molecular gelling agents; fats which are solid at ambient temperature and pressure, in particular chosen from waxes, pasty fats and butters; and mixtures thereof, and preferably among the polymeric gelling agents.

Such lipophilic gelling agents are described in particular in WO2019002308.

Among the lipophilic gelling agents which can be used in the present invention, mention may be made of esters of dextrin and of fatty acid, such as dextrin palmitates. Among the esters of dextrin and of fatty acid(s), mention may be made e.g. of dextrin palmitates, dextrin myristates, dextrin palmitates/ethylhexanoates and mixtures thereof. Mention may be made in particular of the esters of dextrin and of fatty acid(s) marketed under the names Rheopearl® D2 (INCI name: dextrin palmitate), Rheopearl@ TT2 (INCI name: dextrin palmitate ethylhexanoate), and Rheopearl® MKL2 (INCI name: dextrin myristate) by Miyoshi Europe, also dextrin palmitate marketed by The Innovation Company.

HIXCIN® R from Elementis specialties (INCI: Trihydroxystearin), OILKEMIA™ 5S polymer from Lubrizol (INCI: Caprylic/Capric Triglyceride (and) Polyurethane-79) or Estogel M from PolymerExpert (INCI: CASTOR OIL/IPDI COPOLYMER & CAPRYLIC/CAPRIC TRIGLYCERIDE), and mixtures thereof, can be also mentioned.

Advantageously, a gelling agent, in particular a lipophilic gelling agent, is a thermosensitive gelling agent, namely a gelling agent which reacts with heat, and in particular is a gelling agent which is solid at ambient temperature and liquid at a temperature greater than 40° C., preferably greater than 50° C.

Advantageously, a gelling agent, in particular a lipophilic gelling agent, is a thixotropic gelling agent or a gelling agent apt to impart thixotropic behavior to the phase which comprises same. Such a thixotropic gelling agent is chosen in particular from pyrogenic silicas treated, if appropriate, to be hydrophobic, described hereinabove.

A dispersion according to the invention may comprise from 0.01% to 100%, more particularly from 0.05% to 99%, preferably from 0.1% to 70%, more particularly from 0.25% to 50%, better from 0.5% to 40%, more particularly from 1% to 30%, and most particularly from 2.5% to 20%, by weight of gelling agent(s) relative to the total weight of the phase comprising same.

Of course, a person skilled in the art would make sure to choose the possible additive(s) of the composition and/or the amount thereof so that the advantageous properties of the dispersion according to the invention, are not altered or not substantially altered by the envisaged admixture. Also, a person skilled in the art would make sure to choose the nature and/or the amount of gelling agent(s) depending on the aqueous or fatty nature of the considered phase of the dispersion according to the invention and/or with regard to the method for manufacturing of said dispersion and/or in order to reach a desired viscosity of the phase in question and/or in order to provide to the continuous phase the desired suspensive character (or power), in particular with regard to the drops of dispersed phase and/or to the reflective particles. Finally, a person skilled in the art will make sure to adjust the parameters of the microfluidic manufacturing method to guarantee the proper functioning thereof, in particular so as to ensure the use of phases with an appropriate fluidity which can be reached in particular by a rise in the temperature of said phases. Such adjustments fall within the general knowledge of a person skilled in the art.

### Additional Compound(s)

According to the invention, a dispersion according to the invention, in particular the continuous phase and/or the dispersed phase, may furthermore comprise at least one additional compound different from the oils, gelling agents, the raw materials which are not compatible or not very compatible with the abovementioned step (i) and/or the abovementioned step (ii), and the abovementioned anionic and cationic polymers

The dispersions according to the invention may thereby further comprise powders; coloring agents, in particular chosen from water-soluble or water-insoluble, liposoluble or not liposoluble, organic or inorganic coloring agents, materials with an optical effect, liquid crystals, and mixtures thereof; fillers, in particular as described in FR1755907; emulsifying and/or non-emulsifying silicone elastomers, in particular as described in EP2353577; texturing agents, or glycerin; preservatives; humectants; stabilizers; chelating agents; emollients; etc. or any usual cosmetic additive; and mixtures thereof.

Also, the dispersions according to the invention may further comprise at least one biological and/or cosmetic active agent chosen from moisturizing agents, cicatrizing agents, depigmenting agents, UV filters, desquamating agents, antioxidant agents, active agents stimulating the synthesis of dermal and/or epidermal macromolecules, skin-relaxing agents, antiperspirant agents, soothing agents, anti-aging agents, scenting agents, anticoagulants, antithrombogenic agents, anti-mitotic agents, anti-proliferation agents, anti-adhesion, anti-migration, cell adhesion promoters, growth factors, antiparasitic molecules, anti-inflammatories, angiogenesis inhibitors, vitamins, hormones, proteins, antifungals, antimicrobial molecules, antiseptics or antibiotics and mixtures thereof. Such active ingredients are described in particular in FR 1,558 849.

Of course, a person skilled in the art would make sure to choose the possible additional compound(s) of the composition and/or the amount thereof so that the advantageous properties of the dispersion according to the invention, are not altered or not substantially altered by the envisaged admixture. Also, a person skilled in the art will make sure to choose the nature and/or the amount of additional compound(s) depending on the aqueous or fatty nature of the phase considered and/or with regard to the method for manufacturing the dispersion.

Such adjustments fall within the general knowledge of a person skilled in the art.

### Viscosity-Increasing Solution

According to a preferred embodiment, the viscosity of the second dispersion phase 16 is advantageously increased in order to maintain the drops 12 in suspension, preferably over a period of time of at least 1 month, preferably at least 3 months, better at least 6 months, and most particularly at least 12 months.

Initially, during the formation of the drops 12, the viscosity of the second phase 16 is advantageously less than 20,000 mPa·s, preferably below 2500 mPa·s, and better is comprised between 300 mPa·s and 3000 mPa·s, and preferably between 400 mPa·s and 2000 mPa·s.

Once the drops 12 have been formed, the viscosity of the second phase 16 is increased to be greater than or equal to 3000 mPa·s, preferably greater than or equal to 5000 mPa·s, more particularly greater than or equal to 10,000 mPa·s, better greater than or equal to 20,000 mPa·s, or even to be completely gelled.

The viscosity also imparts a texture pleasant to the touch to the dispersion 10.

The increase in viscosity, or even the gellification thereof, is obtained by injection of a viscosity-increasing solution, according to the method which will be described hereinbelow.

In the case where the second phase 16 is an aqueous phase, the viscosity-increasing solution is e.g. a solution containing a base, in particular an alkali hydroxide, such as sodium hydroxide.

The viscosity is measured at ambient temperature and at ambient pressure, by the method described in WO2017046305.

In a variant, in the case where the phase 16 is aqueous, the oily drops 12 can accumulate on the surface of the container 33 which receives the dispersion 10, if the viscosity of the second phase 16 is not modified.

In such case, the drops 12 are arranged to bear on one another. Consequently, the dispersion comprises at least one concentrated region including drops 12 and at least one region devoid of drops 12 and comprising exclusively the second phase 16.

Given the foregoing, a solution for increasing the viscosity of the second phase is different from an additional solution according to the invention.

### Method

Steps (i) and (ii) of a method according to the invention can be carried out according to a microfluidic method described in WO2012/120043, WO2015/055748 or WO2019145424.

The first method according to the invention is implemented using a microfluidic method, in a device 30 illustrated in FIG. 3.

The apparatus 30 includes a nozzle 32 for forming the drops 12, a stage 31 for injecting the solution comprising at least one raw material which is not compatible or not very compatible with step (i) and/or step (ii) and a container 33 for receiving the drops 12 formed.

In the case of a single dispersion, the forming nozzle 32 includes at least one internal line 34 for bringing an internal fluid 36 comprising the first phase 14, and an external flow line 38, arranged around the internal line 34 for bringing and making flow an external fluid 40 forming at least part of the second phase 16.

The apparatus 30 further includes conveying means 46 for bringing the internal fluid 36 into the internal line 34, and conveying means 48 for bringing the external fluid 40 into the annular space delimited between the internal line 34 and the external line 38.

In the example shown in FIG. 3, the maximum diameter of the lines 34 and 38 is less than 3 mm, so as to preserve the microfluidic character of the method.

The internal line 34 is advantageously disposed coaxially in the external line 38. Same is connected upstream to the conveying means 46. Same opens downstream via a downstream opening 54 arranged in the external line 38.

The external line 38 delimits with the internal line 34 an annular space connected upstream to the conveying means 48.

The external line 38 has a downstream opening 55 which is situated above and at a distance from the container 33. Same comes out in the injection stage of the solution 62 comprising at least one raw material which is not compatible or not very compatible with the abovementioned step (i) and/or step (ii).

The conveying means 46 and 48 each include e.g. a syringe pusher, a peristaltic pump or another pressure generating system controlling the flow-rate, such as e.g. a pressure pot coupled to a flow meter and a flow regulation system.

Each of the conveying means 46 and 48 is suitable for conveying a respective fluid 36 and 40 at a controlled and adjustable flow-rate.

In the case of a multiple dispersion, the formation nozzle 32 includes at least one internal line 34 for bringing a third internal fluid 36 comprising the first phase 14, and an intermediate line 37 for bringing an intermediate fluid 39 intended to form a third phase 19 arranged around the internal line 34.

Such embodiment is illustrated in FIGS. 4 and 5.

The formation nozzle 32 further includes an external flow line 38, arranged around the internal line 34 and/or the intermediate line 37 for bringing and make flow an external fluid 40 forming at least part of the second phase 16.

The apparatus 30 further includes conveying means 46 for bringing the internal fluid 36 into the internal line 34, conveying means 47 for bringing intermediate fluid 39 into the intermediate line 37, and conveying means 48 for bringing the external fluid 40 into the annular space delimited between the internal line 34 and the external line 38.

In the example shown in FIG. 5, the maximum diameter of the lines 34, 37 and 38 is less than 3 mm, so as to preserve the microfluidic character of the method.

The internal line 34 is advantageously disposed coaxially in the external line 38. Same is connected upstream to the conveying means 46. Same comes out downstream via a downstream opening 52 arranged in the external line 38, set back with respect to the downstream opening 54 defined by the intermediate line 37, above the opening 54.

According to a first variant, the distance separating the downstream opening 52 of the internal line 34 and the downstream opening 54 of the intermediate line 37 is preferably greater than 1 times the diameter of the intermediate line 37.

According to a second variant, the distance separating the downstream opening 52 of the internal line 34 and the downstream opening 54 of the intermediate line 37 is preferably less than 1 times the diameter of the intermediate line 37, even advantageously, the downstream opening 52 of the internal line 34 and the downstream opening 54 of the intermediate line 37 are located on the same horizontal plane.

The intermediate line 37 extends around the internal line 34. Same delimits with the internal line 34 an annular space connected upstream to the conveying means 47. The intermediate line 37 comes out through the downstream opening 54.

The external line 38 delimits with the intermediate line 37 and/or the internal line 34 an annular space coupled upstream to the conveying means 48.

The external line 38 has a downstream opening 55 which is situated above and at a distance from the container 33. Same comes out into the viscosity-increasing stage 31.

The conveying means 46, 47 and 48 each include e.g. a syringe pusher, a peristaltic pump or another pressure generating system controlling the flow-rate, such as, e.g., a pressure pot coupled to a flow meter and to a flow-rate regulating system.

Each of the conveying means 46, 47 and 48 is suitable for conveying a respective fluid 36, 39, 40 at a controlled and adjustable flow-rate.

According to the invention, the stage 31 includes at least one line 60 for injecting a solution 62 and means 64 for bringing the solution 62 into the line 60.

For the two alternative embodiments of the first manufacturing method described hereinabove, the stage 31 includes at least one line 60 for injecting a solution 62 comprising at least one raw material which is not compatible or not very compatible with the abovementioned stage (i) and/or stage (ii), and means 64 for bringing the solution 62 into the line 60.

In the example shown in FIG. 3, the stage 31 includes a peripheral line 60 for injecting the solution 62.

The peripheral line 60 extends at the periphery of the external flow line 38, in parallel, and in the present case coaxially, the local axis of the external line 38. The downstream opening 55 of the external line 38 extends into the peripheral line 60.

The peripheral line 60 defines, downstream of the downstream opening 55, a dispensing opening 66 which comes into the container 33 or above same.

The peripheral line 60 delimits, with the external line 38, an annular space which comes out upstream of the dispensing opening 66 in the example shown in FIG. 3.

Thereby, the peripheral line 60 is configured to allow the solution 62 to be injected coaxially with the axis of circulation of the dispersion containing drops 12 and the second phase 16, just at the outlet of the external flow line 38.

In the present example, the peripheral line 60 is suitable for collecting the drops 12 and the second phase 16 into which the solution 62 has been fed, and to convey same to the dispensing opening 66.

The conveying means 64 include a tank 68 containing the solution 62, and a conveying unit (not shown).

The conveying unit includes e.g. a syringe pusher, a peristaltic pump or another pressure generating system controlling the flow-rate, such as a pressure pot coupled with a flow meter and a to a flow regulation system.

For the two alternative embodiments of the first manufacturing method described hereinabove, the container 33 is arranged below the dispensing opening 66.

In a variant, the container contains a volume 70 of liquid intended to form part of the second phase 16, advantageously a volume of external fluid 40.

Also, the upper surface of the volume 70 of fluid is situated axially away from the dispensing opening 66, taken along the axis A-A′ of the line 60, in such a way that the drops 12 dispersed in the second phase 14 fall under the effect of the weight thereof through a volume of air between the dispensing opening 66 and the upper surface of the volume 70 of liquid. In a variant (not shown), the downstream opening 66 is immersed in the volume of liquid 70.

In the examples shown in FIGS. 3 and 5, the device 30 was illustrated with only one nozzle 32, associated with only one stage 31.

In an advantageous variant, illustrated in FIG. 8, the system 30 includes a plurality of nozzles 32, all connected downstream to a common stage 31, the nozzles 32 being arranged in parallel above a container 33. The nozzles 32 are offset laterally with respect to the stage 31. A collection circuit serves to collect the drops 12 in the liquid 40 at the outlet of each nozzle 32 in order to collect same and feed same into the stage 31.

A first method according to the invention intended for manufacturing a single dispersion, implemented in the installation shown in FIG. 3, will now be described.

Initially, the internal fluid 36 is prepared by mixing the first phase 14 intended to form the drop 12 and optionally a first polymer precursor of the coacervation and/or at least one gelling agent, more particularly a thermosensitive agent.

In said example, the internal fluid 36 is advantageously oily. The first phase 14 contains at least one oil, and optionally at least one first polymer precursor of the coacervation and/or at least one gelling agent, more particularly a thermosensitive agent. The precursor polymer is lipophilic, and advantageously cationic.

The external fluid 38 is also formed. In said example, the external fluid 38 is aqueous. Optionally, same contains at least one hydrophilic gelling agent, preferably thermosensitive, and/or at least one second coacervation precursor polymer, herein a water-soluble polymer, e.g. of anionic type.

For obvious reasons, the steps of mixing the constituent compounds of the first phase and of the second phase are carried out under suitable conditions to form fluid phases compatible with the microfluidic method according to the invention. In particular, and if need be, the step of mixing the constituent compounds of the first phase takes place under hot conditions, and in particular at a temperature of between 6° and 100° C., preferably between 70 and 90° C. Such is particularly the case when a phase comprises at least one thermosensitive gelling agent.

Advantageously, the internal fluid 36 and/or the external fluid 38 may also comprise at least one additional compound as defined hereinabove.

A solution 62 is also prepared. The solution is advantageously aqueous.

The internal fluid 36 and the external fluid 40, respectively, then are arranged in the respective conveying means 46 and 48.

The solution 62 is arranged in the conveying means 64.

Optionally, a solution for increasing the viscosity of the second phase 16 (or continuous phase) is also prepared. According to a first variant, the viscosity-increasing solution, at least the compound(s) causing the increase of viscosity, is mixed with the solution 62. Thereby, the injection of the solution 62 and of the viscosity-increasing solution into the second phase 16 is simultaneous.

According to a second variant of embodiment, the viscosity-increasing solution is independent of the solution 62 and can be injected before and/or after the solution 62, preferably after the solution 62.

The viscosity-increasing solution is advantageously aqueous. Same includes a base, in particular an alkali hydroxide, such as sodium hydroxide. According to a variant of embodiment, the solution 62 and the viscosity-increasing solution are one and the same solution.

Optionally, a liquid 70, formed of an aqueous solvent of a nature similar to the nature of the external fluid 40, is fed into the container 33.

The conveying means 46, 48 and 64, or even a conveying means specific to the viscosity-increasing solution when the latter is independent of the solution 62, then are activated.

The flow of the internal fluid 36 circulating in the internal line 34 enters coaxially into the line 38 at the downstream opening 54 of the internal line 34.

The internal fluid 36 is then surrounded by the external fluid 40 in the intermediate line 37.

At the downstream opening 54 of the internal line 34, drops 12 of internal fluid 36, [are] surrounded by an external fluid film 40.

The drops 12 then circulate in the external fluid 40 toward the downstream opening 55.

When present, the first coacervate precursor polymer present in the internal fluid 36 migrates to the interface between the drops 12 and the external fluid 40.

Similarly, when present, the second coacervate precursor polymer present in the external fluid 40 migrates to the interface between the external fluid 40 and each drop 12. Coacervation between the first polymer and the second polymer then occurs to form the shell 18.

Since the first polymer and the second polymer are not initially present in the same phase, there is a risk that same will react prematurely, in particular before the formation of the drops 12 of internal fluid 36 in the external fluid 40. Such risk can be limited, or even completely overcome, by using an intermediate fluid 39 devoid of precursor polymers, as illustrated in FIG. 5 and described in WO2012120043 or by using at least one gelling agent in the inner phase 34. Indeed, the gelling agent, in addition to the contribution thereof to improving the mechanical strength of the drops, also serves to reduce the reaction kinetics between the two coacervate precursor polymers, as described in WO2017046305.

The drops 12 thereby formed are thus very stable, not very or not elastic and do not tend to coalesce on each other.

The drops 12 stabilized in the external fluid 40 then arrive into the stage 31.

The solution 62 is then injected coaxially with the flow of drops 12 into the external fluid 40, at the periphery of the external fluid 40. The solution 62 diffuses into the external fluid 40 during the transport thereof through the downstream part of the peripheral line 60.

As indicated hereinabove, it may be necessary to increase the viscosity of the external fluid 40, after formation of the drops 12, in particular to ensure a satisfactory suspension of the drops in the external fluid 40 and/or to achieve the desired texture. Advantageously, the external fluid 40 is gelled.

Similarly, the pH of the external fluid 40 is neutralized.

The increase in viscosity and neutralization, if appropriate, takes place in the vicinity of the dispensing opening 66, before, simultaneously or after the injection of the solution 62, just before feeding the dispersion 10 into the container 33.

At least one drop 12 is then received in an external drop 72 of external fluid 40 which is formed at the outlet of the peripheral line 60, at the dispensing opening 66.

The outer drop 72 falls into the container 33 through a volume of air and the drops 12 of the first phase 14 remain suspended in the second phase 16 formed by the external fluid 40 and by the liquid 70 when such a liquid is present in the container 33.

In a variant, the external fluid 40 forms a jet at the outlet of the peripheral line 60 and is collected without being fragmented. Preferably, the jet becomes narrower between the outlet of the peripheral line 60 and the container 33, in order to reduce the diffusion time of the viscosity-increasing agent.

The injection of the solution 62, or even the neutralization and increase in viscosity of the second phase 16, are thus carried out in a quite non-invasive way, and directly in line with the manufacture of the drops 12.

The above guarantees the use of an aqueous phase that is sufficiently fluid to permit an adequate formation of drops 12 at the nozzle 30 while guaranteeing a robust method of manufacturing the drops. Nevertheless, the final product may comprise raw materials which are not compatible or not very compatible with the abovementioned step (i) and/or step (ii), moreover in high contents, or even a satisfactory viscosity, in order to impart same a pleasant texture, without adversely affecting the stability of the drops 12 formed, via a continuous, easy, safe and cost-effective manufacturing method.

The method according to the invention is thus particularly effective for forming stable drops 12, of dimensions greater than 100 μm, more particularly greater than 250 μm, better greater than 500 μm, in stable suspension in a phase 16, without the use of surfactants and in a particularly controlled manner.

The method according to the invention limits the shear, since the continuous second phase 16 containing the drops 12 remains fluid until the last moment. No force is generated to deform or fragment the drops 12 when the solution 62, or even when the viscosity of the continuous phase, is injected.

Creaming is also reduced. The diffusion time of the viscosity-increasing solution 62 in the continuous phase 16 is very short, given the small thickness to get through. The continuous phase 16 almost immediately acquires a suspensive character when same is collected in the container 33.

In the variant shown in FIGS. 6 and 7, the peripheral line 60 comes out just at the outlet of the external line 38. The downstream edge of the peripheral line 60 is situated at the same horizontal level as the downstream edge of the external line 38.

The dispensing opening 66 is then situated at the same horizontal level as the downstream opening 55 of the external flow line 38.

Furthermore, the stage 31 comprises a central line 80 for the injection of at least part of the solution 62, which extends to the center of the external flow line 38.

In the present example, the central line 80 comes out just at the outlet of the external line 38. The downstream edge thereof is situated at the same horizontal level as the downstream edge of the external line 38.

The dispensing opening 82 of the central line 80 is thus situated at the same horizontal level as the downstream opening 55 of the external flow line 38 and the dispensing opening 66 of the peripheral line 60.

Such conformation reduces the thickness of the flow comprising the drops 12, the external fluid 40, and the solution 62, since the flow becomes thinner by gravity by penetrating into the volume of air situated at the outlet of the lines 38, 60, 80, as illustrated in FIG. 7.

The mixing of the solution 62, or even the increase in viscosity, in the external fluid 40 is then very homogeneous.

In a variant illustrated by FIG. 8, the manufacturing method includes a step of increasing the viscosity, carried out in two sub-steps.

In a first sub-step 100, a first solution 62 and a viscosity-increasing solution are injected simultaneously just after the formation of the drops 12, and before same are collected in the container 33.

The intermediate dispersion 102 obtained at the end of the first sub-step 100 then has a continuous phase 16 which suspends the drops 12, while remaining manipulable.

The viscosity of the continuous phase 16 in the intermediate dispersion 102 is e.g. less than 15000 mPa·s and comprised between 2500 mPa·s and 10000 mPa·s.

The intermediate dispersion 102 can then be made circulate, by gravity, by suction, or by pressure applied to the dispersion 102.

Advantageously, the solution 62 is injected exclusively through a central injection line 80. Preferably, as in the configuration shown in FIG. 6, the central line 80 comes out at the end of the external flow line 38, so that a thinned flow forms in a volume of air and falls, by gravity, into the container.

The free fall and the low impact on reception homogenize the intermediate dispersion 102.

In a second sub-step 104, the intermediate dispersion 102 is then recirculated in an additional line 106, provided at the end thereof with at least one line 60, 80 for injecting a second viscosity-increasing solution, which contains the missing amount of base.

Preferably, the injection lines 60, 80 are shaped as in the apparatus 30 shown in FIG. 6, with a peripheral line 60 and a central line 80.

The final dispersion 10 is then recovered in the container 33.

### Uses

Preferably, a dispersion according to the invention can be used directly, at the end of the aforementioned preparation methods, as a composition, in particular a cosmetic composition.

The invention further relates to the use of a dispersion according to the invention for the preparation of a composition, in particular a cosmetic, pharmaceutical, nutritional or food-processing composition, preferably a cosmetic composition and more particularly a care composition and/or making up composition for a keratin material, more particularly the skin.

The present invention thereby further relates to a composition, in particular a cosmetic composition, more particularly a care composition and/or a makeup composition for a keratin material, in particular the skin and/or the hair, and more particularly the skin, comprising at least one dispersion according to the invention, optionally in combination with at least one physiologically acceptable medium.

The dispersions or compositions according to the invention can thus be used in particular in the cosmetic field.

Same may comprise, in addition to the abovementioned ingredients or compounds, at least one physiologically acceptable medium.

The physiologically acceptable medium is generally suitable for the nature of the support to which the composition is to be applied, as well as to the appearance wherein the composition is to be packaged.

According to one embodiment, the physiologically acceptable medium is represented directly by the aqueous continuous phase as described hereinabove.

Within the framework of the invention, and unless otherwise mentioned, a “physiologically acceptable medium” means a medium which is suitable for cosmetic applications, and which is suitable in particular for the application of a composition of the invention to a keratin material, in particular the skin and/or the hair, and more particularly the skin.

The cosmetic compositions of the invention may be e.g. a cream, a lotion, a serum and a gel for the skin (hands, face, feet, etc.), a foundation (liquid, paste) or a preparation for bath and shower (salts, foams, oils, gels, etc.), a hair care product (hair dyes and bleaches), a cleansing product (lotions, powders, shampoos), a hair care product (lotions, creams, oils), a styling product (lotions, lacquers, brilliants), a shaving product (soaps, foams, lotions, etc.), a product intended to be applied to the lips, a suncare product, a tanning product in the absence of sun, a skin whitening product, and an antiwrinkle product. More particularly, the cosmetic compositions of the invention may be an anti-aging serum, a youth serum, a moisturizing serum or a fragrant water.

Thereby, given the foregoing, a dispersion or composition according to the invention is oral or topical, preferably topical, and better topical on a keratin material, more particularly the skin, and better the face skin.

The present invention further relates to a non-therapeutic method for the cosmetic treatment of a keratin material, in particular the skin and/or the hair, and more particularly the skin, comprising a step of applying to said keratin material at least one dispersion or at least one abovementioned cosmetic composition.

The present invention further relates to the use of a dispersion or of a composition according to the invention, for improving the surface appearance of the skin, more particularly for moisturizing the skin and/or reducing wrinkles and fine lines.

Throughout the description, the expression “comprising a” should be understood as synonymous with “comprising at least one”, unless otherwise specified. The expressions “comprised between . . . and . . . ”, “from . . . to . . . ” and “ranging from . . . to . . . ” are to be understood as including the boundaries, unless otherwise specified.

Particular examples of implementation of the method according to the invention for obtaining dispersions 10 will now be described.

### EXAMPLES

Unless otherwise indicated, for each of the examples below, 3 dispersions are obtained according to the three microfluidic manufacturing methods A, B and C described hereinbelow. Steps (i) and (ii) are carried out by means of a microfluidic device as described in WO2012120043.
Method A (comparative): the method is based on a microfluidic device into which are injected a first oily phase and a second hydrophilic phase comprising at least one raw material which is not compatible or not very compatible with the abovementioned step (i) and/or step (ii), and then optionally a solution for increasing the viscosity of the second phase (BF). The raw material(s) is/are thus present in the second phase before formation of the drops. The microfluidic device of method A is thus devoid of a line dedicated to the injection of an additional solution (AF), as defined by the present invention (i.e. line 60 for the injection of a solution 62). The dispersion obtained will be referred to as dispersion A.
Method B (comparative): method in 2 successive and distinct steps comprising (i) Step 1: manufacture of an “intermediate” dispersion based on injection into a microfluidic device of a first oily phase and a second hydrophilic phase devoid of raw material which is not compatible or not very compatible with the abovementioned step (i) and/or step (ii); (ii) Step 2: after recovery of the intermediate dispersion, addition of an additional solution comprising at least one starting material which is not compatible or not very compatible with abovementioned step (i) and/or step (ii), and homogenization with a Rayneri to obtain a final dispersion. Optionally, method B may further comprise a step of adding a solution for increasing the viscosity of the second phase (BF), subsequent to step 2. The device is thus devoid of a line dedicated to the injection of an additional solution. The dispersion obtained will be referred to as dispersion B.
Method C (invention): the method is based on a microfluidic device wherein are injected a first oily phase and a second hydrophilic phase devoid of raw material which is not compatible or not very compatible with abovementioned step (i) and/or step (ii). A solution comprising the raw material(s) (additional solution) is added to the second phase after formation of the drops, but before recovery of the dispersion, by means of a microfluidic device provided with an injection line 60 for injecting an additional solution. Optionally, the microfluidic device is further provided with an injection line for injecting a solution for increasing the viscosity of the second phase (BF) after formation of the drops, but before recovery of the dispersion, said line being positioned so as to inject the viscosity-increasing solution after the injection of the additional solution. The dispersion obtained will be referred to as dispersion C.

### Example 1: Dispersion Comprising Reflective Particles in Second Phase

Tables 1 to 4 below give the compositions of the respective different phases in methods A, B and C. Table 5 below gives the parameters chosen for the implementation of methods A, B and C.

TABLE 1
Composition of the Internal Fluid 36 (IF)

| Name | INCI name | Weight % |
|---|---|---|
| Lanol 99 | Isononyl Isononanoate | Q.S.* |
| RheoPearl D2 | Dextrin palmitate | 10.00 |
| Scent | Scent | 0.50 |
| CAS-3131 | Amodimethicone | 0.50 |

| | |
|---|---|
| Total | 100.00 |

Q.S.: The amount which is sufficient.

TABLE 2
Composition of the external fluid 40 (OF)

| Method/dispersion | | A | B | C |
|---|---|---|---|---|
| Name | INCI name | Weight % | | |
| Osmosed water | Water | Q.S.* | | |
| Glycerine | Glycerin | 5.29 | 2.94 | |
| codex (99%) | | | | |
| Zemea | Propanediol | 6.26 | | |
| propanediol | | | | |
| Microcare PE | Phenoxyethanol | 1.00 | 0.99 | |
| Microcare | Pentylene glycol | 2.50 | | |
| emollient | | | | |
| PTG | | | | |
| Rhodicare T | Xanthan gum | 0.12 | | |
| Tego carbomer | Carbomer | 0.25 | | |
| 340 FD | | | | |
| SUNSHINE | Sunshine Super Bronze- | 0.31 | — | — |
| SUPER | Synthetic Florflogoppit + | | | |
| BRONZE | Fe2O3-ColorEffectPigment | | | |
| [C84-6282] | | | | |
| MIRAGE | Calcium Sodium | 0.62 | — | — |
| SPARKLING | Borosilicate (and) Iron | | | |
| LUXURY | Oxides (and) Tin | | | |
| GOLD | Oxide (and) Silica (and) | | | |
| | Titanium Dioxide | | | |
| Polynat T-11 | Astragalus Gummifer Gum | 0.06 | — | — |

| | | | |
|---|---|---|---|
| Total | 100.00 | 100.00 | 100.00 |

TABLE 3
Composition of the additional solution comprising
pearlizers (AF methods B and C only)

| Name | INCI name | Weight % |
|---|---|---|
| Osmosed water | Water | Q.S.* |
| SUNSHINE SUPER | Sunshine Super Bronze-synthetic | 2.63 |
| BRONZE [C84-6282] | Florflogoppit + Fe2O3-Color | |
| | effect Pigment | |
| MIRAGE SPARKLING | Calcium Sodium Borosilicate (and) | 5.27 |
| LUXURY GOLD | Iron Oxides (and) Tin Oxide (and) | |
| | Silica (and) Titanium Dioxide | |
| Polynat T-11 | Astragalus Gummifer Gum | 0.50 |
| Glycerine codex (99%) | Glycerin | 20.00 |
| Microcare PE | Phenoxyethanol | 1.00 |

| | |
|---|---|
| Total | 100.00 |

TABLE 4
Composition of the viscosity-increasing
solution of the second phase (BF)

| Name | INCI name | Weight % |
|---|---|---|
| Osmosed water | Water | Q.S.* |
| NaOH | Sodium hydroxide | 5.60 |

| | |
|---|---|
| Total | 100.00 |

TABLE 5
Phase and temperature distribution

| | Method A | Methods B and C | Temperature |
|---|---|---|---|
| | % w/w | | (in ° C.) |
| Internal fluid 36 | 10.10% | 10.10% | 80 |
| External fluid 40 | 85.90% | 75.90% | 80 |
| Additional solution (AF) | — | 10% | **AT |
| BF | 4 | 4 | **AT |

| | |
|---|---|
| Total | 100% |

**AT: Ambient Temperature.

### Results:

Method A: non-functional method (blockages of the line corresponding to the second phase) beyond a few minutes.
Method B: Final dispersion with kinetic stability and a suspension of drops of about 1 mm in diameter in the satisfactory aqueous continuous phase.

Disadvantages: method in 2 steps, hence complex; rapid sequence of the 2 steps required otherwise at risk of observing a creaming of the drops, hence increased risk of errors; integrity of the drops altered following the shear (even soft) generated by step 2; and presence of field lines observed in the continuous phase (i.e. localized zones where the density of the drops is lower or even zero).
Method C: Final dispersion with kinetic stability and a suspension of drops of about 1 mm in diameter in the satisfactory aqueous continuous phase, without the drawbacks observed with method B.

Advantages: (i) easy 1-step method; (ii) preserved drop integrity; and (iii) absence of field lines in the continuous phase.

### Example 2: A Dispersion Comprising Core/Shell Drops and Natriquest E30 in the Second Phase

There is a growing consumer demand for natural cosmetic products, as illustrated by the standard ISO 16128. Having the above in mind, the inventors were interested in replacing EDTA (INCI: Ethylenediaminetetraacetic acid), a raw material that further reinforces the stability of a dispersion according to the invention, by a raw material with equivalent effect, but which is biodegradable, Natriquest E30 (INCI: Trisodium Ethylenediamine Disuccinate).

However, the inventors have observed that Natriquest E30 leads to the neutralization of the carbomer(s) and hence to an increase in the viscosity of the external fluid which, depending on the concentration of Natriquest E30 or carbomer(s), can reach values incompatible with the microfluidic method.

Tables 6 to 9 below give the compositions of the respective different phases in methods A, B and C. Table 10 below gives the parameters chosen for the implementation of methods A, B and C.

TABLE 6
Composition of the Internal Fluid 36 (IF)

| Name | INCI name | Weight % |
|---|---|---|
| DUB ININ | Isononyl Isononanoate | Q.S.* |
| Meadowfoam oil | Limnanthes alba seed oil | 18.00 |
| EMI30 | Castor Oil/IPDI Copolymer (and) | 33.33 |
| | Isononyl Isononanoate | |
| PHAT BLUE | PHAT BLUE | 0.00092 |
| CAS-3131 | Amodimethicone | 0.15 |

| | |
|---|---|
| Total | 100.00 |

Q.S.: The amount which is sufficient.

TABLE 7
Composition of the external fluid 40 (OF)

| Method/Dispersion | | A | B | C |
|---|---|---|---|---|
| Name | INCI name | Weight % | | |
| Osmosed water | Water | Q.S.* | | |
| Glycerine codex | Glycerin | 6.26 | | |
| (99%) | | | | |
| Microcare PE | Phenoxyethanol | 0.89 | 0.77 | |
| Microcare emollient | Pentylene glycol | 2.22 | | |
| PTG | | | | |
| Carbopol ETD | Carbomer | 0.33 | | |
| 2050 polymer | | | | |
| Natrlquest E30 | Trisodium | 0.17 | — | — |
| | Ethylenediamine | | | |
| | Disuccinate | | | |

| | | | |
|---|---|---|---|
| Total | 100.00 | 100.00 | 100.00 |

TABLE 8
Composition of the additional solution comprising
Natrlquest E30 (AF - methods B and C only)

| Name | INCI name | Weight % |
|---|---|---|
| Osmosed water | Water | Q.S.* |
| Natrlquest E30 | Trisodium Ethylenediamine Disuccinate | 1.44 |
| Microcare PE | Phenoxyethanol | 1.00 |

| | |
|---|---|
| Total | 100.00 |

TABLE 9
Composition of the viscosity-increasing
solution of the second phase (BF)

| Name | INCI name | Weight % |
|---|---|---|
| Osmosed water | Water | Q.S.* |
| NaOH | Sodium hydroxide | 5.60 |

| | |
|---|---|
| Total | 100.00 |

TABLE 10
Phase and temperature distribution

| | Method A | Methods B and C | Temperature |
|---|---|---|---|
| | % w/w | | (in ° C.) |
| Internal fluid 36 | 10.10% | 10.10% | 80 |
| External fluid 40 | 85.90% | 75.90% | 80 |
| Additional solution (AF) | — | 10% | **AT |
| BF | 4 | 4 | |

| | |
|---|---|
| Total | 100% |

**AT: Ambient Temperature.

### Results:

Method A: The viscosity of the external fluid is such that the method is non-functional; jetting is observed at the outlet of the microfluidic device, and hence the formation of drops of very elongate shape and of very polydisperse size.

Method B: Final dispersion with kinetic stability and a suspension of drops of about 1 mm in diameter in the satisfactory aqueous continuous phase.

Disadvantages: method in 2 steps, hence complex; rapid sequence of the 2 steps required, otherwise there is a risk of observing a creaming of the drops, hence increased risk of errors; integrity of the drops altered following the shear (even soft) generated by step 2; and presence of field lines observed in the continuous phase (i.e. localized zone where the density of drops is lower, or even zero).

Method C: Final dispersion with kinetic stability and a suspension of drops of about 1 mm in diameter in the satisfactory aqueous continuous phase, without the drawbacks observed with method B.

Advantages: easy 1-step method; preserved drop integrity; and absence of field lines in the continuous phase.

### Example 3: Dispersion Comprising a UV Filter in the Second Phase

UV filters are used to absorb or reflect UV rays contained in sunlight or artificial light. UV filters are used to protect the skin from the harmful effects of UV rays (skin cancer, skin lesions and wrinkles) and/or to protect and stabilize products and the ingredients thereof, as well as packaging, herein Eusolex 232 (INCI: Phenylbenzimidazole Sulfonic Acid) given the satisfactory protective properties, the solubility in water, and the worldwide regulatory acceptance thereof.

Tables 11 to 14 below give the compositions of the respective different phases/solutions in methods A, B and C. Table 15 below gives the parameters chosen for the implementation of methods A, B and C.

TABLE 11
Composition of the Internal Fluid 36 (IF)

| Name | INCI name | Weight % |
|---|---|---|
| Labrafac CC | Caprylic/Capric triglyceride | Q.S.* |
| Meadowfoam oil | Limnanthes alba seed oil | 25.00 |
| EMC30 | Castor Oil/IPDI Copolymer (and) | 33.33 |
| | Caprylic/Capric Triglyceride | |

| | |
|---|---|
| Total | 100.00 |

TABLE 12
Composition of the external fluid 40 (OF)

| Method/Dispersion | | A | B | C |
|---|---|---|---|---|
| Name | INCI name | Weight % | | |
| Osmosed water | Water | Q.S.* | | |
| Pentiol Green+/ | Pentylene glycol | 3.01 | 2.89 | |
| A-LEEN 5 | | | | |
| PureCare CHP XO | Chlorophenesin | 0.34 | | |
| Zemea select | Propanediol, Aqua | 12.47 | | |
| Propanediol | | | | |
| Carbopol Ultrez 10 | Carbomer | 0.25 | | |
| Polymer | | | | |
| Eusolex 232 | Phenylbenzimidazole | 0.58 | — | — |
| | Sulfonic Acid | | | |
| Unicert Red 07004-J | Cl14700 | 0.30 | | |
| 10% SODIUM | AQUA, SODIUM | 0.19 | 0.11 | |
| HYDROXIDE | HYDROXIDE | | | |
| SOLUTION | | | | |

| | | | |
|---|---|---|---|
| Total | 100.00 | 100.00 | 100.00 |

TABLE 13
Composition of the additional solution comprising
the UV filter (AF - methods B and C only)

| Name | INCI name | Weight % |
|---|---|---|
| Osmosed water | Water | Q.S.* |
| Pentiol Green+/A-LEEN 5 | Penylene glycol | 5 |
| Eusolex 232 | Phenylbenzimidazole | 24.07 |
| | Sulfonic Acid | |
| NaOH | Sodium hydroxide | 3.33 |

| | |
|---|---|
| Total | 100.00 |
| pH | 7 |

TABLE 14
Composition of the viscosity-increasing
solution of the second phase (BF)

| Name | INCI name | Weight % |
|---|---|---|
| Osmosed water | Water | Q.S.* |
| NaOH | Sodium hydroxide | 5.60 |

| | |
|---|---|
| Total | 100.00 |

TABLE 15
Phase and temperature distribution

| | Method A | Methods B and C | Temperature |
|---|---|---|---|
| | % w/w | | (in ° C.) |
| Internal fluid 36 | 12% | 12% | 80 |
| External fluid 40 | 85.92% | 83.86% | 80 |
| Additional solution (AF) | — | 2.07% | **AT |
| BF | 2.075% | 2.07% | **AT |

| | |
|---|---|
| Total | 100% |

**AT: Ambient Temperature.

### Results:

Method A: Final dispersion with an opaque and white continuous phase with the presence of particles that may lead to blockages of the microfluidic device.

Method B: Final dispersion with kinetic stability and a suspension of drops of about 1 mm in diameter in the satisfactory aqueous continuous phase.

Disadvantages: method in 2 steps, hence complex; rapid sequence of the 2 steps required, otherwise there is a risk of observing a creaming of the drops, hence increased risk of errors; integrity of the drops altered following the shear (even soft) generated by step 2->opacification of the second phase; and presence of field lines observed in the continuous phase (i.e. localized zone where the density of drops is lower, or even zero).

Method C: Final dispersion with kinetic stability, a transparent continuous phase and a suspension of drops of about 1 mm in diameter in the satisfactory aqueous continuous phase, without the disadvantages observed with method B.

Advantages: easy 1-step method; preserved drop integrity; and absence of field lines in the continuous phase.

### Example 4: Dispersion Comprising a Raw Material Apt to Modify the Surface Tension in the Second Phase

Tables 16 to 19 below give the compositions of the respective different phases/solutions in methods A, B and C. Table 20 below gives the parameters chosen for the implementation of methods A, B and C.

TABLE 16
Composition of the Internal Fluid 36 (IF)

| Name | INCI name | Weight % |
|---|---|---|
| Labrafac CC | Caprylic/Capric triglyceride | Q.S.* |
| Meadowfoam oil | Limnanthes alba seed oil | 25.00 |
| EMC30 | Castor Oil/IPDI Copolymer (and) | 33.33 |
| | Caprylic/Capric Triglyceride | |

| | |
|---|---|
| Total | 100.00 |

TABLE 17
Composition of the external fluid 40 (OF)

| Method/Dispersion | | A | B | C |
|---|---|---|---|---|
| Name | INCI name | Weight % | | |
| Osmosed water | Water | Q.S.* | | |
| Pentiol Green+/ | Pentylene glycol | 3.01 | | |
| A-LEEN 5 | | | | |
| PureCare CHP | Chlorophenesin | 0.34 | | |
| XO | | | | |
| Microcare | Pentylene glycol | 2.50 | | |
| emollient PTG | | | | |
| Zemza select | Propanediol, Aqua | 12.47 | | |
| Propanediol | | | | |
| Carbopol | Carbomer | 0.2503 | | |
| Ultrez 10 | | | | |
| Polymer | | | | |
| EDETA BD | Disodium EDTA | 0.0125 | | |
| Biophytex | Aqua (and) Butylene | 2.49 | — | — |
| LS 9832 | Glycol (and) Panthenol | | | |
| | (and) Escin (and) | | | |
| | Glycerin (and) Ruscus | | | |
| | Aculeatus Root Extract | | | |
| | (and) Ammonium | | | |
| | Glycyrrhizate (and) | | | |
| | Centella Asiatica | | | |
| | Extract (and) Hydrolyzed | | | |
| | Yeast Protein (and) | | | |
| | Calendula Officinalis | | | |
| | Flower Extract | | | |

| | | | |
|---|---|---|---|
| Total | 100.00 | 100.00 | 100.00 |

TABLE 18
Composition of the additional solution
(AF - methods B and C only)

| | | Weight |
|---|---|---|
| Name | INCI name | % |
| Biophytex | Aqua (and) Butylene Glycol (and) Panthenol | 100 |
| LS 9832 | (and) Escin (and) Glycerin (and) Ruscus | |
| | Aculeatus Root Extract (and) Ammonium | |
| | Glycyrrhizate (and) Centella Asiatica Extract (and) | |
| | Hydrolyzed Yeast Protein (and) Calendula | |
| | Officinalis Flower Extract | |

| | |
|---|---|
| Total | 100.00 |

TABLE 19
Composition of the viscosity-increasing
solution of the second phase (BF)

| Name | INCI name | Weight % |
|---|---|---|
| Osmosed water | Water | Q.S.* |
| NaOH | Sodium hydroxide | 7.41 |

| | |
|---|---|
| Total | 100.00 |

TABLE 20
Phase and temperature distribution

| | Method A | Methods B and C | Temperature |
|---|---|---|---|
| | % w/w | | (in ° C.) |
| Internal fluid 36 | 17% | 17% | 80 |
| External fluid 40 | 80.925% | 77.925% | 80 |
| Additional solution (AF) | — | 3.00 | **AT |
| BF | 2.075% | 2.075% | **AT |

| | |
|---|---|
| Total | 100% |

**AT: Ambient Temperature.

### Results:

Method A: Poor formation of drops, hence accumulation of IF, at the microfluidic device, which leads to clogging and hence to a non-functional method.

Method B: Final dispersion with kinetic stability and a suspension of drops of about 1 mm in diameter in the satisfactory aqueous continuous phase.

Disadvantages: method in 2 steps, hence complex; rapid sequence of the 2 steps required, otherwise there is a risk of observing a creaming of the drops, hence increased risk of errors; integrity of the drops altered following the shear (even soft) generated by step 2->opacification of the second phase; and presence of field lines observed in the continuous phase (i.e. localized zone where the density of drops is lower, or even zero).

Method C: Final dispersion with kinetic stability, a transparent continuous phase and a suspension of drops of about 1 mm in diameter in the satisfactory aqueous continuous phase, without the disadvantages observed with method B.

Advantages: Easy 1-step method; preserved drop integrity; and absence of field lines in the continuous phase.

### General Conclusion of Examples 1 to 4

Of the three methods A, B and C, only method C satisfies the desired goal, namely to have an easy “microfluidic” method for manufacturing a dispersion containing drops in stable suspension in a phase comprising raw materials which are not compatible or not very compatible with step (i) of microfluidic emulsification and/or step (ii), while minimizing the handling to be carried out on the product.

With regard to example 2, the neutralization of carbomers, related to Natrlquest E30 is thus carried out at a stage which remains compatible with the intrinsic viscosity requirements of the microfluidic method according to the invention.

1. A method of forming a dispersion comprising drops, the method including the following steps:
(i) formation of drops of a first phase in a second phase substantially immiscible with the first phase;
(ii) flow, in a flow line, of the drops;
(iii) recovery of a dispersion comprising drops and second phase in a container;
wherein the method includes at least one of the following steps:
(iv) injection of a solution into the flow line or at the outlet of the flow line, upstream of the container, said solution comprising at least one raw material which is not or is not very compatible with step (i) and/or step (ii).

2. The method according to claim 1, wherein each drop comprises a core formed of a first phase and a shell.

3. The method according to claim 1, wherein the drops having a diameter greater than or equal to 100 μm represent a volume greater than or equal to 60%, or even greater than or equal to 70%, preferably greater than or equal to 80%, and better greater than or equal to 90% of the total volume of the dispersed phase and/or at least 60%, even at least 70%, preferably at least 80% and better at least 90%, of the drops have a mean diameter greater than or equal to 100 μm.

4. The method according to claim 1, wherein the solution comprises between 0.1% and 60%, preferably between 0.25% and 40%, more particularly between 0.5% and 20%, and in particular between 1% and 10%, in weight of raw material(s) which are not compatible or not very compatible with step (i) and/or step (ii) relative to the weight of the solution.

5. The method according to claim 1, wherein the drops and the second phase flow along a local axis in the flow line, the injection of the solution taking place substantially parallel to the local axis.

6. The method according to claim 1, wherein the injection of the solution includes bringing at least part of the solution to the center of the flow of the drops and of the second phase.

7. The method according to claim 1, wherein the injection of the solution includes bringing at least part of the solution to the periphery of the flow of drops and of the second phase.

8. The method according to claim 1, wherein the injection of the solution is carried out at the outlet of the flow line.

9. The method according to claim 1, wherein the method includes, upstream of the flow step (ii), a step of forming drops in the flow line.

10. The method according to claim 9, wherein the step of formation of the drops comprises the following sub-steps:
supply of a first fluid comprising the first phase and optionally at least one first precursor polymer of the coacervate and/or at least one gelling agent, preferably thermosensitive, contained in the first phase;
formation of drops of first fluid in a second fluid intended to form the second phase, the second fluid advantageously circulating in the flow line upstream of the injection of the solution;
optionally, supply of at least one second precursor polymer of the coacervate and/or of at least one gelling agent, preferably thermosensitive, in the second fluid.

11. The method according to claim 1, wherein the injection of the solution includes bringing at least part of the solution into a solution dispensing ring located in the center of the flow line, the drops-flowing through a central passage delimited by the ring and through a peripheral passage delimited between the ring and the flow line.

12. The method according to claim 1, wherein the method includes at least one injection step (v) of injecting a solution for increasing the viscosity of the second phase such that the solution is injected into the flow line or at the outlet of the flow line, upstream of the container, before, simultaneously with or after the solution injection step.

13. The method according to claim 12, wherein the viscosity-increasing solution comprises at least one base.

14. An apparatus for forming a dispersion comprising drops, comprising:
a flow line containing drops of first phase in a second phase substantially immiscible with the first phase, optionally each drop comprising a core formed of first phase and a shell, preferably formed of a coacervate layer interposed between the first phase and the second phase;
a container for collecting a dispersion comprising drops and the second phase;
wherein the apparatus includes:
a tank containing a solution comprising at least a raw material which is not compatible or not very compatible with the step (i) of formation of drops and/or the step (ii) of flow in the flow line;
at least one injection line for injecting the solution, coupled to the tank, and coming into the flow line or at the outlet of the flow line, upstream of the container.

15. The apparatus according to claim 14, wherein the flow line extends along a local axis of circulation of the drops and of the second phase, the injection line coming out coaxially with the local axis.

16. The apparatus according to claim 14, wherein the apparatus includes a peripheral injection line for injecting at least part of the solution, coming out at the periphery of the flow line and/or a central injection line for injecting at least part of the solution, coming out at the center of the flow line.

17. The apparatus according to claim 14, wherein the apparatus includes a unit for forming drops in the circulation line, the unit for forming drops including:
a line for supplying a first fluid comprising the first phase and optionally a first precursor polymer of the coacervate and/or at least one gelling agent, preferably thermosensitive, contained in the first phase;
a line for forming drops of first fluid in a second fluid intended to form the second phase, optionally the second fluid containing or receiving a second precursor polymer of the coacervate and/or at least one gelling agent, preferably a thermosensitive agent.
